(19) United States
(12) Patent Application Publication
(10) Pub. No.: US 2006/0288397 A1
(43) Pub. Date: Dec. 21, 2006

(54) STREAM CONTROLLER

(75) Inventors: Jun UCHIDA, Osaka (JP); Toshio HIGUCHI, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/424,313

(22) Filed: Jun. 15, 2006

(30) Foreign Application Priority Data
Jun. 17, 2005 (JP) 2005/178186

(51) Int. Cl. H04N 7/173; H04N 7/16

(52) U.S. Cl. 725/115; 725/91; 725/145

(57) ABSTRACT

The stream controller includes: (a) a stream management unit that gives a priority level of a streaming process; and (b) an event management unit that reschedules data transfer notifications so as to start the streaming processes in sequence, based on the priority levels of the streaming processes, in order to eliminate conflicts among the data transfer notifications and prevent a streaming process executed on a CPU from being put on hold.

### BACKGROUND OF THE INVENTION

(1) Field of the Invention

The present invention relates to a stream controller used for a multi-encode system and the like in which plural units of stream data with various formats, including audio and video data inputted via a camera, a TV tuner, a network and the like, are simultaneously processed.

(2) Description of the Related Art

In recent years, formats of streams have been diversified with improvements in information compression technology and communication technology, and technology which can operate plural streams with a single system has been developed. The special purpose processors, such as a digital signal processor (DSP) which can perform parallel processing on a plurality of streams, have been advancing, and there are numerous systems made up of a central processor unit (CPU) and a DSP.

For example, in a system made up of a plurality of encoders (for example, DSPs) and a CPU, in the case where a stream inputted from a camera or a TV tuner is recorded in a medium, such as an hard disk drive (HDD) and an secure digital (SD) memory card, the recording is generally performed via a file system. In the case where such process is performed by software at the CPU side, the process time occupies a large percentage of the stream's time constraints. Using a commercial real-time operating system (OS) on a general-purpose CPU, best-effort type scheduling is performed. Therefore, in the case where a plurality of streams are handled, the process may put a heavy load on the CPU, and as a result, it may affect the real-time functionality.

In the case where a plurality of streams are processed, there are devices, such as a device shown in Japanese Laid-Open Patent Application No. 2001-45025 Publication, for reducing the load on the CPU. Although with this method, a plurality of streams can be processed without depending on the CPU performance, it is necessary to separately prepare hardware other than the CPU.

Here, advancement of general-purpose processors used as CPUs is striking, and the cost is inexpensive. In addition, software resources of a real-time OS are abundant, and lot of support is provided for processing file systems and the like. Therefore, in the stream recording processes, distributing the processes to the CPU side is very effective.

However, even when the process performance of CPUs is improved, in the case where a plurality of streams are handled in a system using the aforementioned real-time OS, the following matters needs to be taken care of.

In the case where encoded data is handled in the CPU side, it is necessary to know the amount of data in the encoded stream. On the other hand, in order to accurately know the amount of data, a method for performing communications with an encoder is used. Specifically, a predetermined amount of a stream is encoded, and upon completion of the transfer from the CPU to an accessible area, an event that notifies the data transfer is reported from the encoder to the CPU.

In addition, a start time of the encoder is determined by random requests from the user, and the time when the encoder notifies the data transfer is determined, aside from the start time. Furthermore, as an interval at which the data transfer notification is reported depends on the bit rate of stream, in the case where a plurality of streams are handled, such asynchronous data transfer notifications conflict with each other on the CPU. The more the number of streams to be processed increases, the more striking this phenomenon becomes.

In conventional system configuration as shown in FIG. 1A, a real-time OS receives asynchronous requests from a plurality of encoders, using such notifications, a streaming process is started. In this case, when a conflict of the data transfer notifications occurs, the streaming process may cause a wait state as shown in FIG. 1B, and as a result, there is a possibility that the streaming process which is put on hold may take longer than the deadline time of the data transfer to the encoder. As the deadline time is determined based on the time when the data transfer notification is issued, it is impossible to avoid such problem in the real-time OS under this configuration when scheduling the processes.

As a method for avoiding a conflict between events, such as a data transfer notification, there is a device as shown in Japanese Patent Application No. 2004-180363 Publication which avoids a data conflict at the time of decoding. Such device reschedules notification time of an event in decoding, by delaying a start time from the user as well as designating the amount of data transferred to the decoder depending on the bit rate of stream.

However, it is not possible to avoid an event conflict in encoding with the same method as decoding. Because in the case where a stream recording is started by the user, the stream data inputted from a camera or a TV tuner is accumulated in a buffer before encoding, and by delaying the start of encoding, there is a possibility that the recorded data which is accumulated in the buffer before encoding may be overwritten, and the stream data which is the data immediately after the recording is started can not be guaranteed.

In addition, although it is possible to control the time when the decoder issues a data request event by variably designating the amount of data transferred to the decoder depending on the bit rate of stream in decoding, the encoder constantly issues a data transfer notification event with a predetermined interval, depending on the buffer size in which the data after encoding is accumulated and the bit rate of stream.

### SUMMARY OF THE INVENTION

The present invention aims at providing a stream controller which can record a plurality of audio or video streams with high efficiency and accuracy even in conventional system configuration, without requiring a CPU and high performance special hardware and reducing efficiency in process time for a plurality of streams.

In order to achieve the aforementioned object, the stream controller according to the present invention: (a) is a stream controller which has a plurality of encoders that respectively encode a stream and which starts, for every encoder, a streaming process for transferring encoded stream data to an external storage device; and includes (b) a stream management table holding unit which holds a stream management table in which a priority level given to a streaming process, process time allocated to the streaming process, and a startup cycle designated for the streaming process are registered for every streaming process; (c) a stream management unit that designates, as a standard process (hereinafter also referred to as a “master process”), a streaming process with a highest priority level among the streaming processes registered in the stream management table and that allocates process time to a streaming process to be registered in the stream management table under a condition that all of the streaming processes registered in the stream management table are sequentially performed within a startup cycle of the standard streaming process; and (d) an event management unit that reallocates process time to each streaming process under a condition that the streaming processes are performed in accordance with the priority levels given to each streaming process and within the startup cycle of the standard streaming process.

With this, when a plurality of streams are recorded, even in the case where a process, such as a file system, relatively occupies a large percentage of the stream's time constraints, it is possible to avoid occurrence of an event conflict from the encoders and prevent a streaming process executed on a CPU from being put on hold by reallocating, in the event management unit, process time to the process time allocated in the stream management unit.

It should be noted that the present invention can be realized, not only as a stream controller, but also as a method for controlling the stream controller (hereinafter referred to as a “stream control method”), as a program causing a computer system and the like to execute such stream control method (hereinafter referred to as a “stream control program”), and as a recording medium in which such stream control program is recorded.

As described, according to the stream controller of the present invention, when a plurality of streams are recorded, even in the case where a process, such as a file system, relatively occupies a large percentage of the stream's time constraints, it is possible to avoid occurrence of an event conflict from the encoders by scheduling a start time of a process and to prevent a streaming process executed on a CPU from being put on hold. Even under the conventional system configuration, the stream controller can record a plurality of audio or video streams with high efficiency and accuracy without requiring a CPU and high-performance special hardware and reducing efficiency in process time for a plurality of streams.

### FURTHER INFORMATION ABOUT TECHNICAL BACKGROUND TO THIS APPLICATION

The disclosure of Japanese Patent Application No. 2005-178186 filed on Jun. 17, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1A is a diagram showing configuration in a conventional method.

FIG. 1B is a diagram showing a scheduling result in a conventional method.

FIG. 2 is a system configuration diagram showing the stream controller of the first embodiment in the present invention.

FIG. 3 is a process block diagram showing the stream controller of the first embodiment in the present invention.

FIG. 4 is a diagram showing configuration of the stream management table in the first embodiment of the present invention.

FIG. 5 is a flowchart of the stream management unit according to the stream controller of the first embodiment in the present invention.

FIG. 6 is a flowchart of the event management unit according to the stream controller of the first embodiment in the present invention (at the start or the end).

FIG. 7 is a flowchart of the event management unit according to the stream controller of the first embodiment in the present invention (during streaming).

FIG. 8 is a diagram showing a scheduling result in the case of executing the stream controller of the first embodiment in the present invention.

FIG. 9 is a process block diagram showing the stream controller of the second embodiment in the present invention.

FIG. 10A is a diagram showing a scheduling result in the case of executing the stream controller of the first embodiment in the present invention.

FIG. 10B is a diagram showing a scheduling result in the case of executing the stream controller of the second embodiment in the present invention.

FIG. 11 is a diagram showing configuration of the stream management table of the second embodiment in the present invention.

FIG. 12 is a flowchart of the stream management unit of the second embodiment in the present invention.

FIG. 13 is a flowchart of the event management unit according to the stream controller of the second embodiment in the present invention (at the start or the end).

FIG. 14 is a process block diagram showing the stream controller of the third embodiment in the present invention.

FIG. 15 is a diagram showing configuration of the stream management table in the third embodiment of the present invention.

FIGS. 16 is a flowchart of the event management unit according to the stream controller of the third embodiment in the present invention (during streaming).

FIG. 17 is a diagram showing a scheduling result in the case of executing the stream controller of the third embodiment in the present invention.

FIG. 18 is a process block diagram showing the stream controller of the fourth embodiment in the present invention.

FIG. 19 is a diagram showing configuration of the stream management table in the fourth embodiment of the present invention.

FIG. 20 is a diagram showing a scheduling result in the case of executing the stream controller of the fourth embodiment in the present invention.

FIG. 21 is a process block diagram showing the stream controller of the fifth embodiment in the present invention.

FIG. 22 is a flowchart of the stream management unit according to the stream controller of the fifth embodiment in the present invention.

FIG. 23 is a process block diagram showing the stream controller of the sixth embodiment in the present invention.

FIG. 24 is a flowchart of the stream management unit according to the stream controller of the sixth embodiment in the present invention.

FIG. 25 is a process block diagram showing the stream controller of the seventh embodiment in the present invention.

FIG. 26 is a flowchart of the stream management unit according to the stream controller of the seventh embodiment in the present invention (in changing a bit rate).

FIG. 27 is a process block diagram showing the stream controller of the eighth embodiment in the present invention.

FIG. 28 is a diagram showing configuration of the stream management table in the eighth embodiment of the present invention.

FIG. 29 is a flowchart of the stream management unit according to the stream controller of the eighth embodiment in the present invention.

FIG. 30 is a flowchart of the event management unit according to the stream controller of the eighth embodiment in the present invention (at the start or the end).

FIG. 31 is a flowchart of the event management unit according to the stream controller of the eighth embodiment in the present invention (during streaming).

FIG. 32 is a diagram showing a change in the stream management table of the eighth embodiment in the present invention.

FIG. 33 is a diagram showing a scheduling result in the case of executing the stream controller of the eighth embodiment in the present invention.

FIG. 34 is a process block diagram showing the stream controller of the ninth embodiment in the present invention.

FIG. 35 is a flowchart of the event management unit according to the stream controller of the ninth embodiment in the present invention (during streaming).

FIG. 36 is a process block diagram showing the stream controller of the tenth embodiment in the present invention.

FIG. 37 is a diagram showing configuration of the stream management table in the tenth embodiment of the present invention.

FIG. 38 is a flowchart of the stream management unit according to the stream controller of the tenth embodiment in the present invention.

FIG. 39 is a flowchart of the event management unit according to the stream controller of the tenth embodiment in the present invention (during streaming).

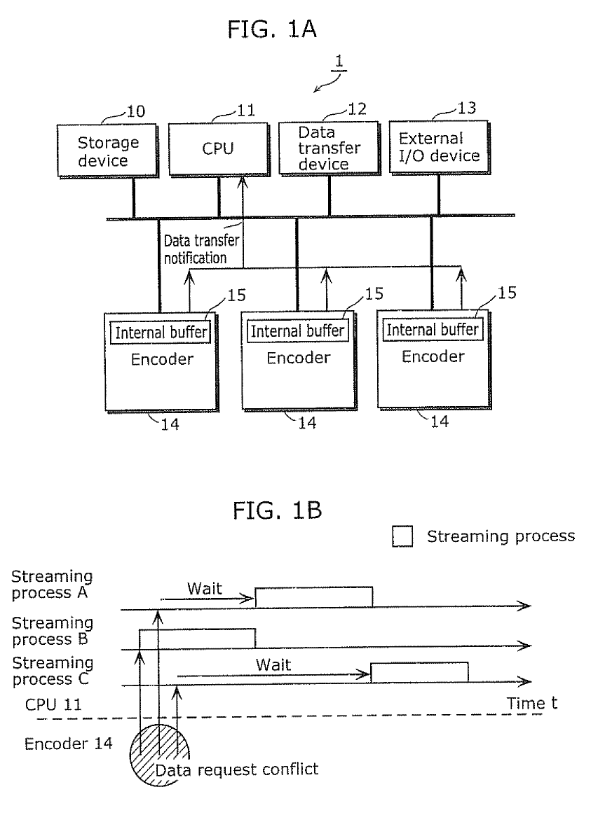

### DESCRIPTION OF THE PREFERRED EMBODIMENTS

### First Embodiment

The first embodiment of the present invention is described hereinafter with reference to the diagrams.

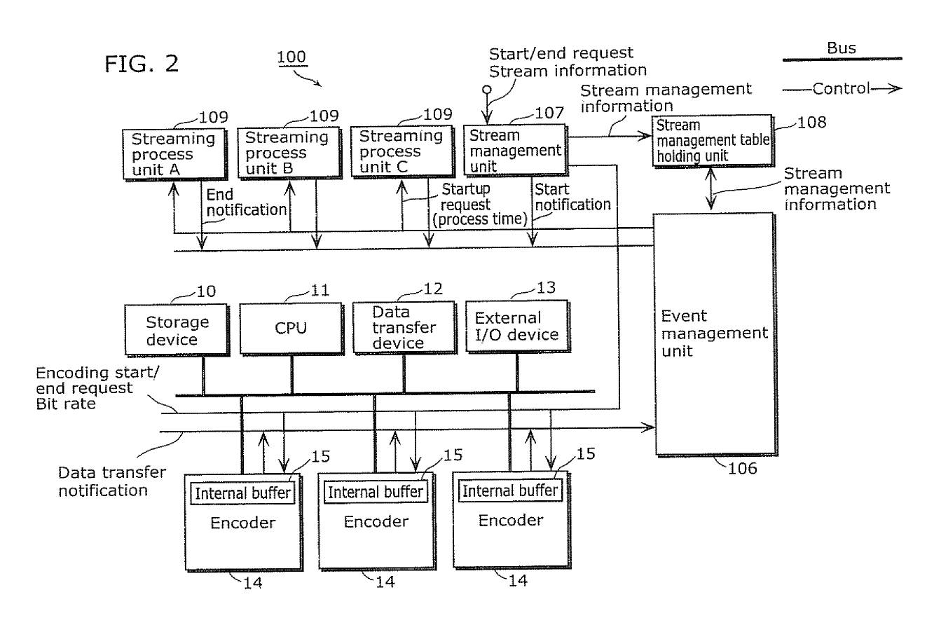

FIG. 2 is a diagram showing system configuration of a stream controller in the first embodiment.

As shown in FIG. 2, a stream controller 100 is characterized in that process time of a streaming process allocated by a stream management unit 107 is reallocated by an event management unit 106. Here, as an example, the stream controller 100 includes: a CPU 11; a data transfer device 12; an external input/output (I/O) device 13; an encoder 14; an internal buffer 15 that temporarily accumulates data after encoding; a streaming process unit 109; an event management unit 106; a stream management unit 107; and a stream management table holding unit 108.

When a stream recording process is started, encoding is started by the encoder 14, and the encoded data is accumulated in the internal buffer 15 of the encoder 14. This encoded data is cyclically transferred to a storage device 10 by the data transfer device 12. When a predetermined amount of the encoded data is transferred to the storage device 10, the data transfer is notified by the encoder 14. The streaming process unit 109 functions by software that operates on the CPU 11. When the streaming process unit 109 detects that the predetermined amount of the encoded data is accumulated in the storage device 10, after performing a streaming process (for example, a process regarding a file system) required for recording, in an external storage device connected to the external I/O device 13 (not illustrated) such as an HDD, the encoded data accumulated in the storage device 10 is recorded in the external storage device. Moreover, the configuration in which the data transfer device 12 notifies data transfer may also be applied.

The stream management unit 107 includes functions such as: generating a stream management table 180 for managing all streaming processes already started by viewing, as input, start and end requests of the encoder 14 and information concerning the stream in which a start of encoding is requested; predicting a start time of the streaming process unit 109 which is already executed, based on the process time of the streaming process unit 109 which receives a start request of encoding; and then detecting an overflow of the internal buffer 15 in the encoder 14.

The event management unit 106 includes a function of rescheduling the asynchronous data transfer notifications received from a plurality of the encoder 14 according to priority levels registered in the stream management table 180 so as to issue the notifications in sequence and an interval by viewing, as input, a data transfer notification from the encoder 14 and stream management information managed by the stream management table 180.

The streaming process unit 109 starts a streaming process when an event notification (start request) is inputted in response to the data transfer rescheduled by the event management unit 106.

The streaming process in the streaming process unit 109 is to convert the encoded data accumulated in the storage device 10 to a necessary format, and to record the data in the external storage device connected to the external I/O device 13, such as an HDD and an SD memory card (hereinafter referred to as a “streaming process”).

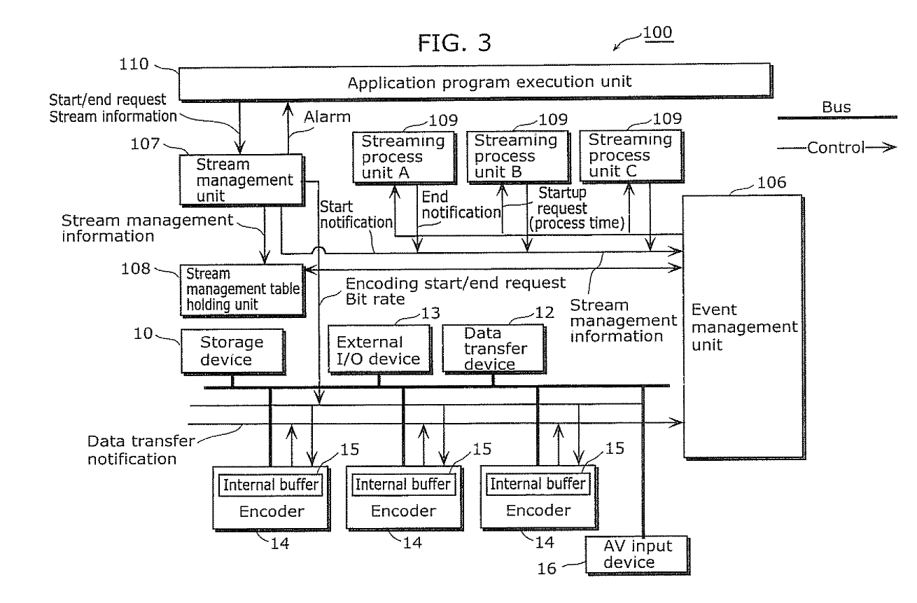

FIG. 3 shows a process block diagram of the first embodiment of the present invention.

As shown in FIG. 3, the stream controller 100 includes: the encoder 14; storage device 10 that accumulates data after encoding; data transfer device 12; stream management unit 107; stream management table holding unit 108; event management unit 106; application program execution unit 110; streaming process unit 109; external I/O device 13; AV input device 16; and the like.

The application program execution unit 110 views, as input, start and end requests for recording from a user, and supplies, to the encoder 14, streams, such as audio or video streams by controlling equipment such as a camera and a TV tuner which are connected via the AV input device 16.

Furthermore, the application program execution unit 110 notifies the stream management unit 107 of start and end requests for recording and information regarding the recording stream.

When the recording starts, the stream management unit 107 views, as input, a recording start request and stream information from the application program execution unit 110, and judges, from process time of the streaming process unit 109 included in the stream information, whether or not the recording process can be started, using the process time of the streaming process already executed and a startup cycle of the process. In the case where the recording process can be started, a start of encoding is requested to the encoder 14 by giving the priority level and the identifier to the streaming process, and the started stream management information is registered in the stream management table 180 held in the stream management table holding unit 108. The encoding start request includes preset values, such as a bit rate of the recording stream and a recording format. Furthermore, the stream management unit 107 issues a start notification to the event management unit 106. Then, the event management unit 106 that receives the start notification obtains the stream management information from the stream management table 180.

As an operation during the recording process, when the event management unit 106 receives the data transfer notification from the encoder 14, using the stream management information obtained from the stream management table 180, the streaming process with the highest priority level is designated as a standard streaming process. Then, the start sequence of the streaming process unit 109 is scheduled so that other streams can be sequentially processed in accordance with the priority levels and based on this master process. The streaming process unit 109 receives a data transfer notification from the event management unit 106, and during the process time included in information of the data transfer notification, the process is performed for recording, in the external storage device connected to the external I/O device 13, the encoded data accumulated in the storage device 10.

When the process is started in the encoder 14, the encoded data is accumulated in the internal buffer 15. When the amount of data in the internal buffer 15 exceeds a predetermined amount, the data transfer device 12 is started, and the encoded data is transferred to the storage device 10. When the encoder 14 transfers the predetermined amount of the encoded data to the storage device 10, the data transfer notification is outputted to the event management unit 106. The amount of data to be transferred from the encoder 14 to the storage device 10 and the amount of data with which the encoder 14 outputs the data transfer notification are designated in the encoder 14 before starting the recording.

In the case where the recording ends, the stream management unit 107 views, as input, a recording end request from the application program execution unit 110, notifies the encoder 14 of the recording end request, and deletes the stream management information regarding the concluded streaming process from the stream management table 180. When the encoder 14 receives the end request, the encoding is stopped, and the encoded data provided with a termination code of the stream is transferred to the storage unit 10.

The streaming process unit 109 detects the termination code of the stream, and notifies the event management unit 106 of the end of the streaming process when finishing recording all stream data in the external storage device. When the event management unit 106 receives the end notification from the streaming process unit 109, it deletes the stream information regarding the concluded streaming process from the table information, and the process ends.

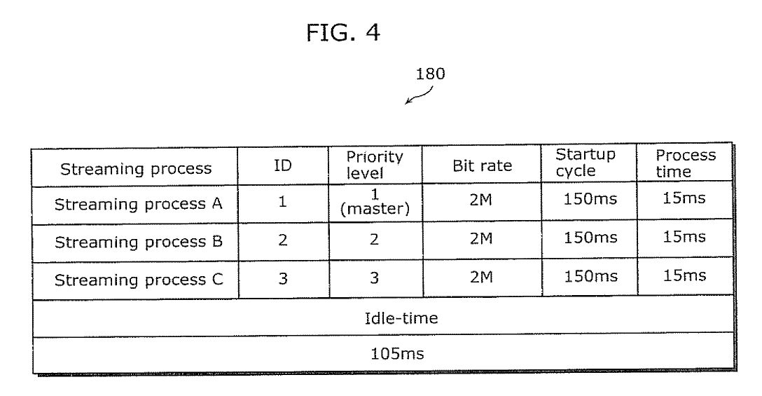

FIG. 4 is a diagram showing the configuration of the stream management table 180 held in the stream management table holding unit 108.

As shown in FIG. 4, the stream management information associated with the stream ID is managed, such as process time per cycle in which the streaming process unit 109 performs a streaming process, the bit rate of stream, and the data transfer notification cycle. The cycle of data transfer notification indicates a time difference between data transfer notification time and next data transfer notification time, in other words, an amount of time until which an arbitrate amount of data designated by the encoded data of the encoder 14 is transferred to the storage device 10, and the cycle is determined, depending on the designated amount of data and the bit rate of stream.

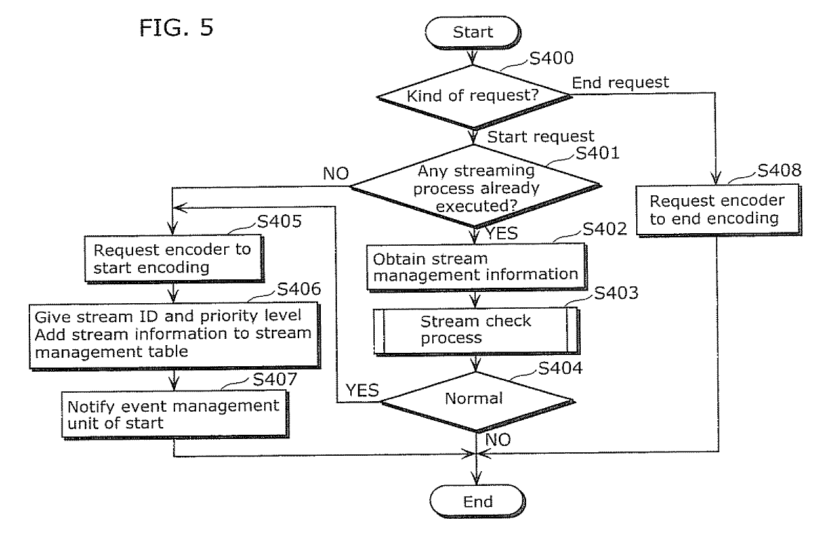

FIG. 5 is a diagram showing a flowchart of the stream management unit 107.

As shown in FIG. 5, in the case of detecting a recording start request from the application program execution unit 110 (S400), by confirming stream management information registered in the stream management table 180 to be described hereinafter, it is judged whether or not a streaming process already started is present (S401). In the case where no stream management information is present, the start of encoding is requested to the encoder 14, and the encoding is started (S405). The stream IDs and priority levels are given in the registered sequence and for respective streaming processes in which the encoding has already been started, and based on this ID, the stream management table 180 is created (S406). Furthermore, the event management unit 106 is notified of the start of the recording process (S407).

In the case where the streaming process already started is present, the stream management unit 107 obtains information about all streaming processes from the stream management table 180 (S402), a stream check process to be described hereinafter is performed by the stream information obtained from the application program execution unit 110 and information of the stream management table 180 (S403). With the stream check process, in the case where it is judged that the streaming process requested to be started delays a start time of the streaming process already started and the data to be recorded in the external storage device can not be guaranteed (S404), the process ends without starting the encoding. In the case where it is judged that a start of the streaming process does not affect other streaming processes (S404), the start of encoding is requested to the encoder 14, and the encoding is started (S405). The stream ID and priority level are given for the streaming process already started, and the stream management information is registered in the stream management table 180 (S406). Finally, the event management unit 106 is notified of the start of the recording process (S407).

The stream check process (S403) is a process for judging whether or not the sum of the process time per cycle of a streaming process to be started and the streaming process time of an already-executed stream exceeds the data transfer notification cycle of the master streaming process.

When the streaming process is started in the case where the sum exceeds the cycle, it indicates that the start time of the streaming process unit 109 is delayed and before recording the encoded data of the storage device 10 in the external storage device, the internal buffer 15 of the encoder 14 or an area where the encoded data of the storage device 10 is accumulated overflows.

The stream management table 180 constantly manages idle-time to be applied for adding a new streaming process, and when a new streaming process time falls within this idle-time, it is possible to add the details of the streaming process including the process time to the table. The idle-time can be obtained by subtracting, from a startup cycle of the master streaming process, the total time taken for all streaming processes already executed (Equation 1). Moreover, in the case where a streaming process is performed by dividing it into the tasks depending on the system, when interrupted response time and task switch time occupy a large percentage of the process time, the idle-time may be corrected by including such times in the streaming process time.
Idle-time=A startup cycle of a process with the priority level 1−Σ(Process time of a streaming process) (Equation 1)

When detecting a recording end request from the application program execution unit 110 (S400), the end of encoding is requested to the encoder 14, and the encoding ends (S408).

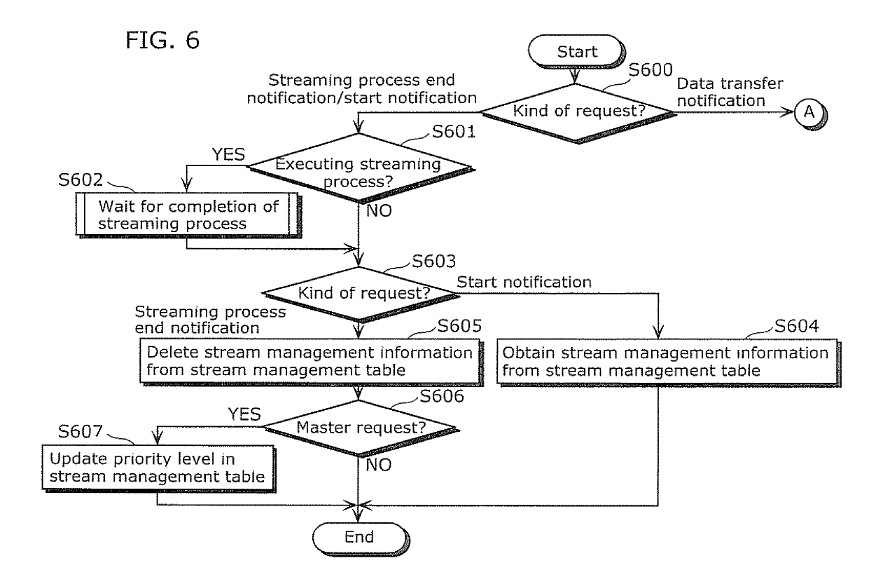

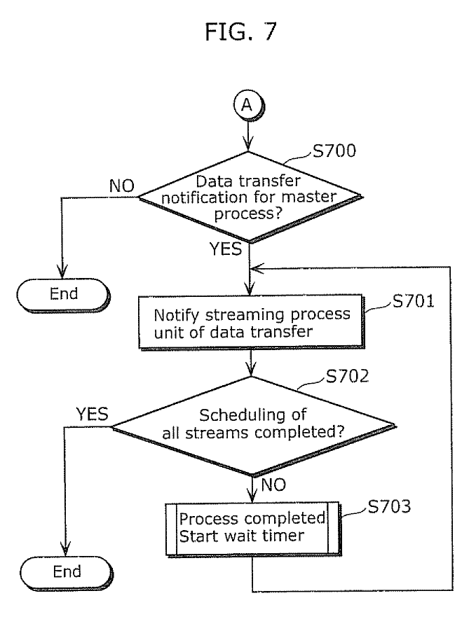

FIG. 6 and FIG. 7 are diagrams showing flowcharts of the event management unit 106.

First, as shown in FIG. 6, the event management unit 106 performs a process in the case of receiving a start notification from the stream management unit 107 and an end notification from the streaming process unit 109. When receiving the start and end notifications (S600), it is judged whether or not the streaming process is started which is performed upon receipt of the data transfer notification to be described hereinafter (S601). When the streaming process is executed (S602), the event management unit 106 waits until the streaming process ends so as not to update information by scheduling during the streaming process (S602), and then performs the succeeding process (S603-S607).

When the stream management unit 107 notifies the start, it obtains the latest stream management information from the stream management table 180 (S604), and the process ends.

When the streaming process unit 109 notifies the end, the stream management information is deleted from the stream management table 180, based on an ID that is corresponding to the stream in which the process ends (S605). Judging whether or not this end notification is the notification of the master streaming process (S606), in the case of the master streaming process, the priority level of the stream management table 180 is updated (S607). It should be noted that in the first embodiment, the process that deletes stream management information from the stream management table 180 is performed in the event management unit 106; however, alternatively, a deletion request may be issued from the event management unit 106 to the stream management unit 107 so that the stream management information may be deleted in the stream management unit 107 side.

Furthermore, as shown in FIG. 7, the event management unit 106 performs a process in the case of receiving a data transfer notification from the encoder 14, and in the case of receiving the data transfer notification from the encoder 14, it is judged whether or not the data transfer notification is a notification to the master streaming process (S700). In the case where it is not, the process ends. In the case where the data transfer notification is a notification to the master streaming process (S700), the data transfer is notified to the streaming process unit 109 (S701). By notifying process time of the streaming process managed by the stream management table 180 as additional information of the data transfer notification, the streaming process unit 109 records, to the external storage device, the encoded data accumulated in the storage device 10 only during this process time. In the case where an additional streaming process is registered in the stream management table 180 (S702), a timer is started, using the streaming process time of the stream management table 180, and the event management unit 106 waits until the started streaming process unit 109 ends the process (S703). After the timer notifies that the time is up, the next streaming process is started by notifying the streaming process unit 109 of the data transfer (S701). The process ends by repeating the aforementioned processes (S701-S703) to each of all streams registered in the stream management table 180.

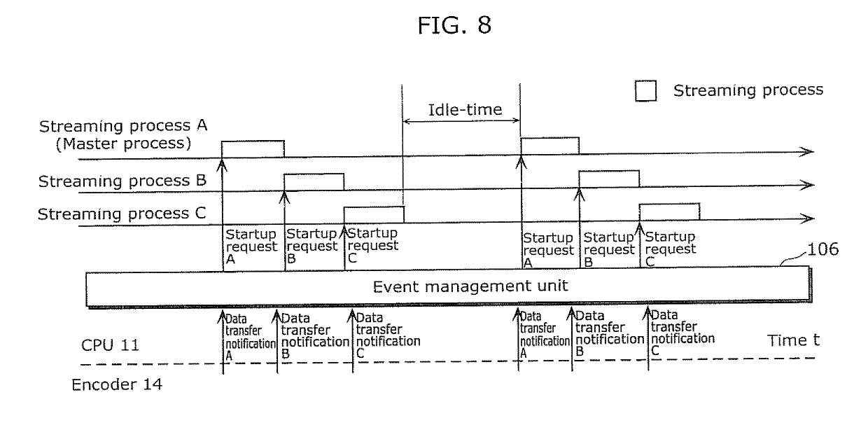

In this manner, in the stream controller 100 of the present embodiment, as a plurality of the streaming process units 109 operated on the CPU 11 by the event management unit 106 are sequentially started in accordance with the priority levels given to each stream as shown in FIG. 8, no conflict occurs in starting the streaming processes in response to the asynchronous data transfer notifications from a plurality of the encoder 14. In addition, for example, it is possible to prevent occurrence of wait in the streaming processes by designating a priority level to each task in a real-time OS. As a result, before an overflow occurs in an encoded data area of the internal buffer 15 or the storage device 10 in response to a plurality of the encoder 14, it is possible to guarantee that data in the storage device 10 is recorded in the external storage device. In addition, in the case where the streaming processes are successively started as shown in FIG. 8, it is possible to manage single idle-time for which the streaming processes are not performed. Therefore, in the case where the streaming processes are started by the stream management unit 107, when these processes ends within the idle-time, it is possible to guarantee in all streaming processes that stream data which is encoded in the encoder 14 is recorded in the external storage device.

### Second Embodiment

Next, the second embodiment of the present invention is described hereinafter with reference to the diagrams.

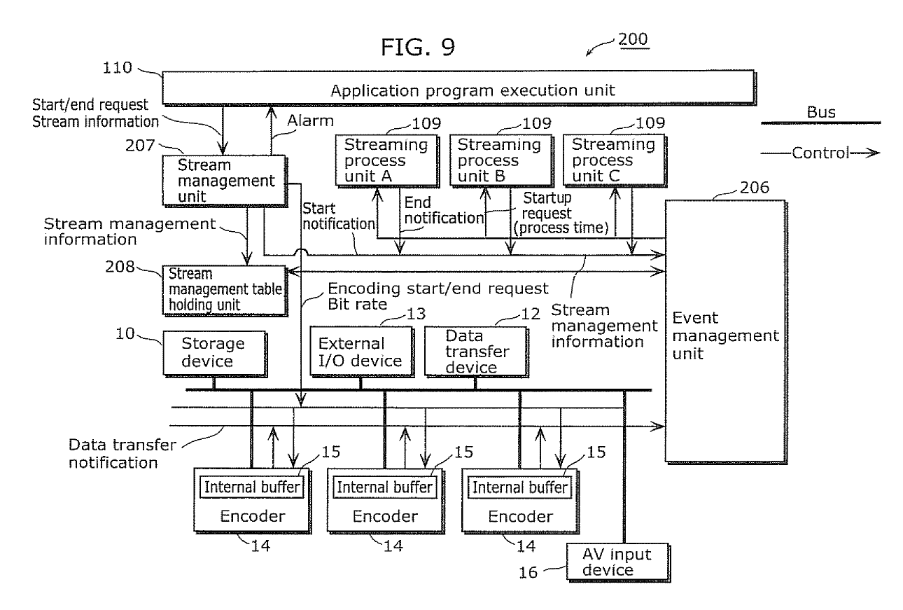

The hardware configuration of the stream controller in the present embodiment is the same as the hardware configuration of the stream controller of the first embodiment. However, in the functional configuration as shown in FIG. 9, instead of the event management unit 106, stream management unit 107, and stream management table holding unit 108, the stream controller of the second embodiment differs in having an event management unit 206, a stream management unit 207 and a stream management table holding unit 208. Then, by modifying the components of the stream management table 180 and adding a band control process to the event management unit 106 and stream management unit 107, the stream controller is characterized in modifying the processes control flows of the event management unit 106 and stream management unit 107.

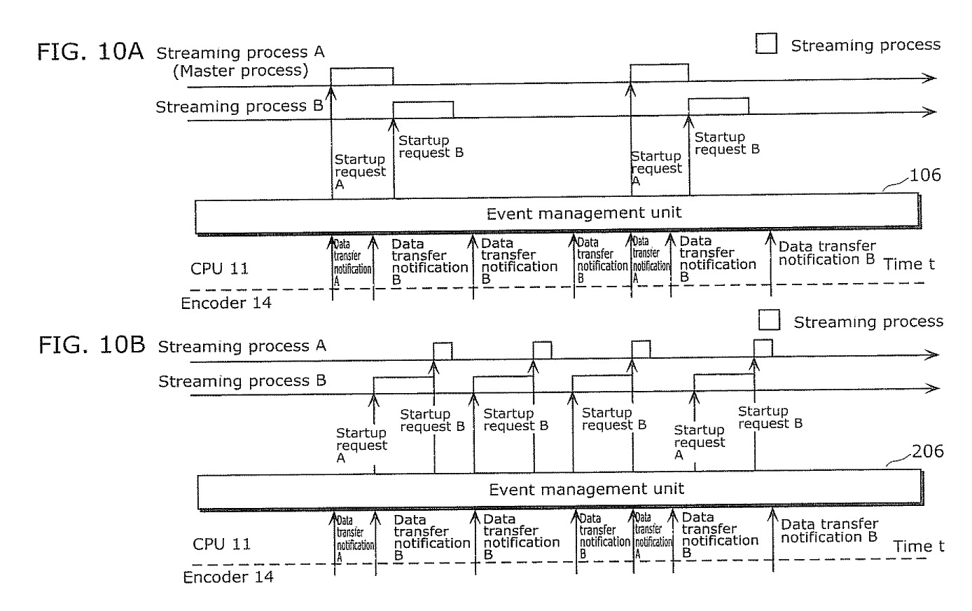

Moreover, according to the stream controller 100 of the first embodiment, as shown in FIG. 10A, in the case of handling plural streams each with a different bit rate, it is not possible to perform a streaming process other than the master streaming process several times while performing a cycle of the master streaming process. Therefore, an overflow occurs in an encoded data accumulation area in the storage device 10 or the internal buffer 15 of the encoder 14.

For example, in the case where a bit rate of a master streaming process A is triple the bit rate of a streaming process B which is not the master streaming process, while the streaming process unit 109 for the streaming process A is started one time, the streaming process unit 109 for the streaming process B needs to be started three times.

However, according to the stream controller in the present embodiment, this point is improved. Specifically, using bit rates of a stream in the stream management unit 207, a process in which a maximum bit rate is prioritized is added, and furthermore, by assuming the maximum bit rate as a standard, the stream management unit 207 dynamically allocates process time of the streaming process unit 109 depending on the bit rate ratio. The event management unit 206 can record a plurality of streams each with a different bit rate by scheduling each stream based on the process time.

Taking the aforementioned points into consideration, the stream controller in the present embodiment is described. It should be noted that the description is omitted in the case where the components of the stream controller in the second embodiment are the same as those of the first embodiment, as the same reference numbers are used in the description.

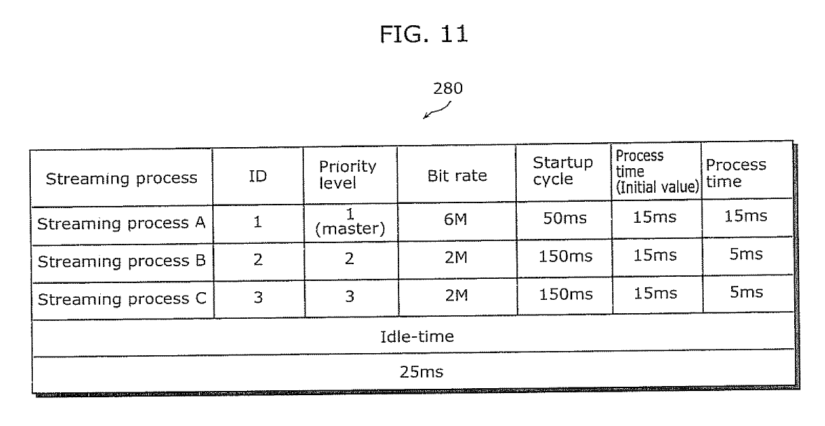

FIG. 11 is a diagram of the stream management table 280 held in the stream management table holding unit 208 of the second embodiment.

As shown in FIG. 11, in the stream management table 280, aside from the initial value, a table section in which process time is designated is added to the stream management table 180 of the first embodiment.

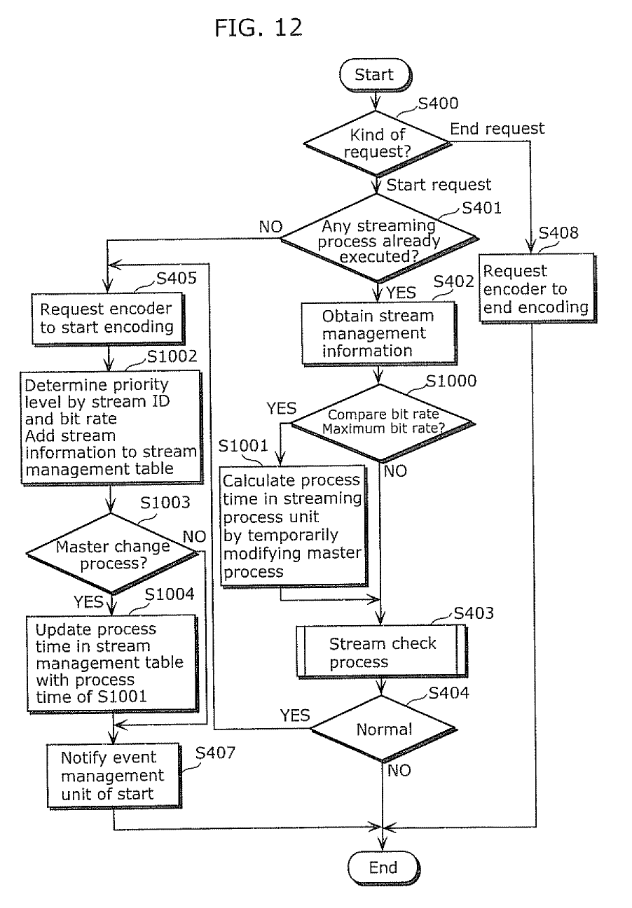

FIG. 12 is a flowchart of the stream management unit 207 in the second embodiment.

It should be noted that the following points are different compared with the control flow (refer to FIG. 5) of the stream management unit 107 in the first embodiment.

As shown in FIG. 12, the stream management unit 207 compares, with a bit rate of a stream of the stream management table held in the stream management table holding unit 208, a bit rate of the streaming process in which the application program execution unit 110 requests the start. In the case where the bit rate of the streaming process in which the start is requested is larger (S1000), the streaming process in which the start is requested is temporarily handled as a master process, and the process time of the streaming process unit 109 is recalculated based on the process time of the master streaming process which is temporarily designated (S1001). The process time of the streaming process other than the master process is obtained by process time of the master streaming process and the bit rate of stream (Equation 2).
Process time for a streaming process with a priority level N=Process time of a process with the priority level 1×(A bit rate of the process with the priority level 1/Process time for the process with the priority level N) (Equation 2)

The stream check process is performed, using the recalculated streaming process time (S403). In the case where the streaming process can be started, the corresponding stream management information is registered in the stream management table 280. In addition, depending on the size of a recording bit rate, the priority levels for the streaming processes other than the master process are determined, and the stream management information is registered (S1002). In the case where the master streaming process is modified (S1003), the recalculated streaming process time is updated in the stream management table 280 (S1004). Then, a recording start is notified to the event management unit 106 (S407) in order to reflect this streaming process time in scheduling, and the process ends.

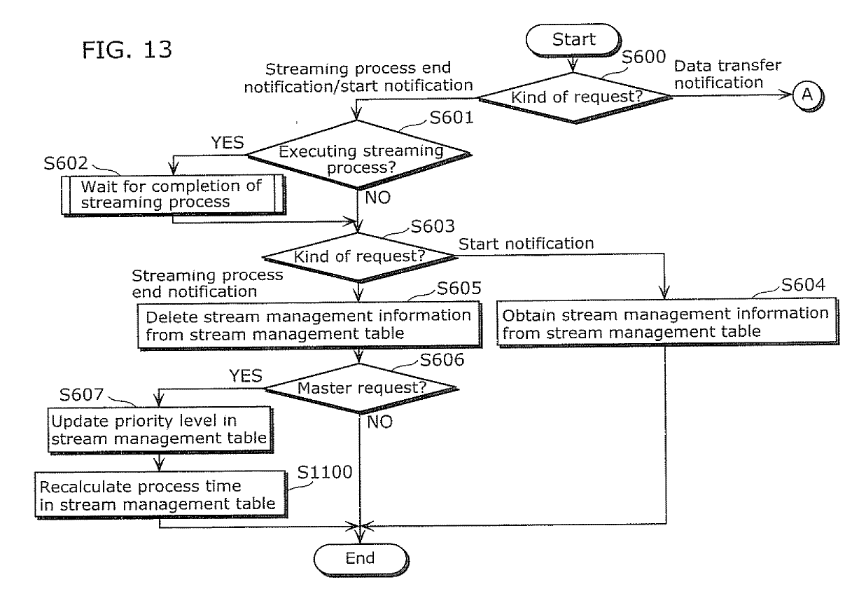

FIG. 13 is a flowchart of the event management unit 206 in the second embodiment.

It should be noted that the following points are different compared with the control flow (refer to FIG. 6) of the event management unit 106 in the first embodiment.

As shown in FIG. 13, when the event management unit 206 receives an end notification of a streaming process from the streaming process unit 109, the stream management information is deleted from the stream management table 280 (S601 to 607). In the case where the stream management information for the master streaming process is deleted, process time in the stream management table 280 is recalculated for a new master process (S1100).

The recalculated process time is registered in the stream management table 280 separately from the initial value, and values after the calculation is used for all scheduling. After the master process is deleted, the process time of the streaming process unit 109 is recalculated using the initial value.

In this manner, according to the stream controller 200 in the present embodiment, the stream management unit 207 determines the priority levels of the streaming process units 109 by the recording bit rate of each stream, and determines each process time of the streaming process units 109 which are other than the master streaming process unit 109 based on the process time of the master streaming process unit 109. Furthermore, by rescheduling the streaming process units 109 in accordance with the priority levels and each process time which are recalculated in the event management unit 206, even in the case where plural streaming processes which respectively differs in the recording bit rate are handled, as shown in FIG. 10B, it is possible to guarantee in all streaming processes to record, in the external storage device, the stream data encoded by the encoder 14.

### Third Embodiment

Next, the third embodiment of the present invention is described hereinafter with reference to the diagrams.

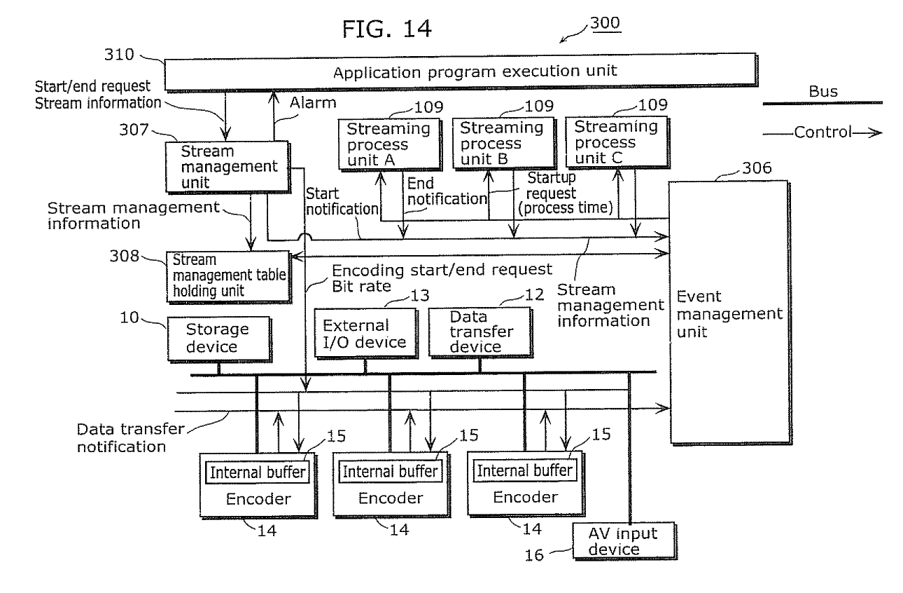

The hardware configuration of the stream controller in the present embodiment is the same as the hardware configuration of the stream controller of the second embodiment. However, in the functional configuration, as shown in FIG. 14, instead of the event management unit 206, stream management unit 207, stream management table holding unit 208 and application program execution unit 110, the stream controller of the third embodiment differs in having an event management unit 306, a stream management unit 307, a stream management table holding unit 308 and an application program execution unit 310. Then, the stream controller is characterized in modifying the process control flow of the event management unit 206 by adding table sections of preprocess time and post-process time to the components of the stream management table 280, further adding input of the preprocess and post-process from the application program execution unit 110 to the stream management unit 207, and adding a scheduling process of the preprocess and post-process to the event management unit 206.

Moreover, in the stream controller 200 of the second embodiment, before and after the streaming process that records, in the external storage device, the encoded data accumulated in the storage device 10, in the case where a predetermined process is necessary, the recording process including such predetermined process can not be guaranteed.

For example, in the case where encryption is performed before starting the streaming process A, and after recording the streaming process B, an operation is added so as to check whether or not the stream data is accurately recorded in the external storage device, as the process time of the process which depends on these streams is not included in the scheduling, consistency in scheduling can not be obtained. As a result, it is not guaranteed that the stream data can be recorded in the external storage device.

However, this point is improved in the stream controller of the present embodiment.

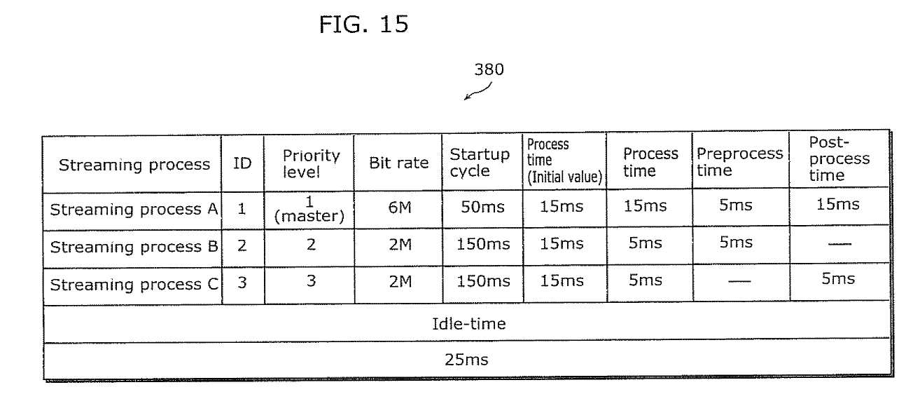

Specifically, as shown in FIG. 15, by adding the table sections of preprocess time and post-process time in the stream management table 380 held in the stream management table holding unit 308 and adding these process times to the streaming process time to perform scheduling, it is guaranteed that the stream data can be recorded in the external storage device so as to include the preprocess and post-process.

Taking the aforementioned points into consideration, the stream controller in the present embodiment is described. It should be noted that the description is omitted in the case where the components of the stream controller in the third embodiment are the same as those of the second embodiment, as the same reference numbers are used in the description.

FIG. 15 is a block diagram of the stream management table 380 held in the stream management table holding unit 308 of the third embodiment.

As shown in FIG. 15, in the stream management table 380, the table sections where the preprocess time and post-process time are designated are added to the stream management table 280 of the second embodiment.

Moreover, the control flow of the stream management unit 307 in the present embodiment is the same as the control flow of the stream management unit 207 in the second embodiment (refer to FIG. 12). However, information of the preprocess and post-process is included in the stream information obtained from the application program execution unit 310, and in the stream check process, idle-time is calculated by including the preprocess time and post-process time as indicated in Equation 3.
Idle-time=A startup cycle of a streaming process with the priority level 1−Σ(Process time of the streaming process+The preprocess time+The post-process time) (Equation 3)

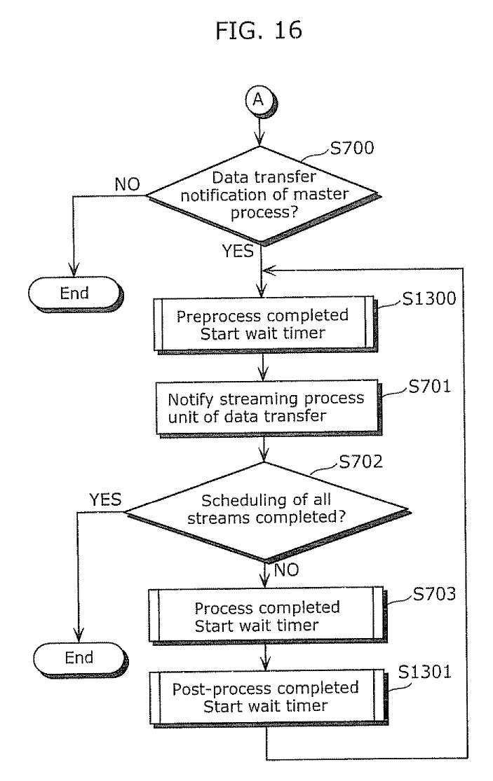

FIG. 16 is a flowchart of the event management unit 306 in the third embodiment.

Moreover, the event management unit 306 synchronizes a start time of the second streaming process with an end time of the first streaming process based on the streaming process time, by assuming that a stream with a higher priority level is the first streaming process and a stream with a lower priority level is the second streaming process among the streaming processes registered in the stream management table 380.

It should be noted that the following points are different compared to the control flow of the event management unit 206 in the second embodiment (refer to FIG. 7).

As shown in FIG. 16, when the event management unit 306 receives a data transfer notification of the master process from the encoder 14, it waits the preprocess time based on the stream management information in the stream management table 380 (S1300), and then notifies data transfer to the streaming process unit 109 (S701). After the streaming process ends, furthermore, the event management unit 306 waits the post-process time (S1301), and perform a scheduling process for the next stream. As start of the streaming process unit 109 is kept waiting for the preprocess time, it is preferable to make, in the storage device 10, the size of the area where encoded data is accumulated variable, depending on the preprocess time.

Moreover, when it is not necessary to perform preprocess and post-process every time, the stream management table 380 may be updated from the application program execution unit 310 when necessary.

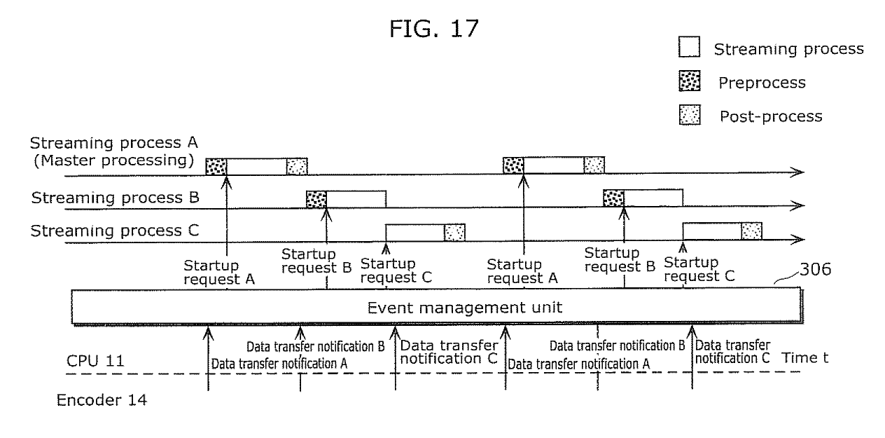

In this manner, according to the stream controller 300 of the present embodiment, by adding the area of preprocess and post-process to the stream management table 380 and scheduling the preprocess and post-process with the inclusion of the streaming process time in the event management unit 306 and the stream management unit 307, it is possible to guarantee that the stream data is recorded in the external storage device so as to include the preprocess and post-process as shown in FIG. 17.

### Fourth Embodiment

Next, the fourth embodiment of the present invention is described hereinafter with reference to the diagrams.

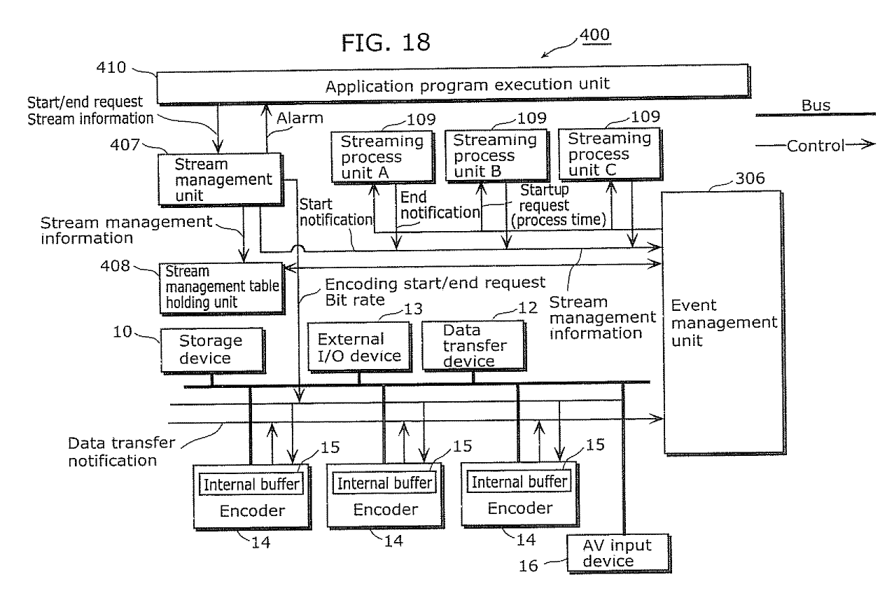

The hardware configuration of the stream controller in the present embodiment is the same as the hardware configuration of the stream controller of the third embodiment. However, in the functional configuration, as shown in FIG. 18, instead of the stream management unit 307, stream management table holding unit 308 and application program execution unit 310, the stream controller of the fourth embodiment differs in having a stream management unit 407, a stream management table holding unit 408, an application program execution unit 410 and the like. In addition, it is also characterized in adding a table section of reserved process time to the components of the stream management table 380 and further adding input of reserved time from the application program execution unit 310 to the stream management unit 307.

Moreover, in the third embodiment, in the case where a predetermined cycle process is required aside from the streaming process in which the encoded data accumulated in the storage device 10 is recorded in the external storage device, only the streaming process can be guaranteed.

For example, in the case where the streaming process A is performed, while a process of transmitting and receiving a network is performed, communication band for the network cannot be guaranteed.

However, this point is improved in the stream controller of the present embodiment.

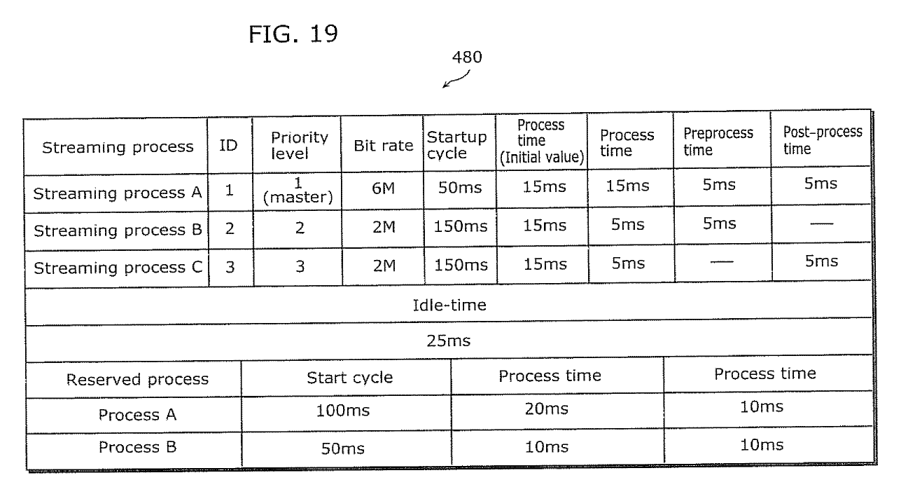

Specifically, as shown in FIG. 19, by adding reserved time to the stream management table 480 held in the stream management table holding unit 408 and inputting the reserved time in the streaming process time so as to perform scheduling, it is possible to guarantee that the stream data is recorded in the external storage device as well as the process ends within the reserved time.

Taking the aforementioned points into consideration, the stream controller in the present embodiment is described. It should be noted that the description is omitted in the case where the components of the stream controller in the fourth embodiment are the same as those of the stream controller 300 in the third embodiment, as the same reference numbers are used in the description.

FIG. 19 is a diagram of the stream management table 480 held in the stream management table holding unit 408 of the fourth embodiment.

As shown in FIG. 19, in the stream management table 480, a table section for designating time for a reserved process is added to the stream management table 380 in the third embodiment.

In addition, although the control flow of the stream management unit 407 in the present embodiment is the same as the control flow of the stream management unit 307 in the third embodiment (refer to FIG. 12), in the stream check process, idle-time is calculated by including reserved time as Equation 4, based on the time for the reserved process designated by the application program execution unit 410.
Idle-time=A startup cycle of a process with the priority level 1−Σ(Process time of the streaming process+Reserved time) (Equation 4)

In addition, the default reserved process time which is initially designated is used for scheduling as recalculated in Equation 5 based on a startup cycle of the master streaming process.
Reserved process time=Default time for the reserved process*(A startup cycle of the reserved process/A startup cycle of the process with the priority level 1) (Equation 5)

Moreover, in order to synchronize a start time of the reserved process with an end time of the streaming process, after performing all streaming processes (S702), the process may be started by notifying the end to the process module in which the reserved time is allocated, in the flowchart of the event management unit 306 (refer to FIG. 16).

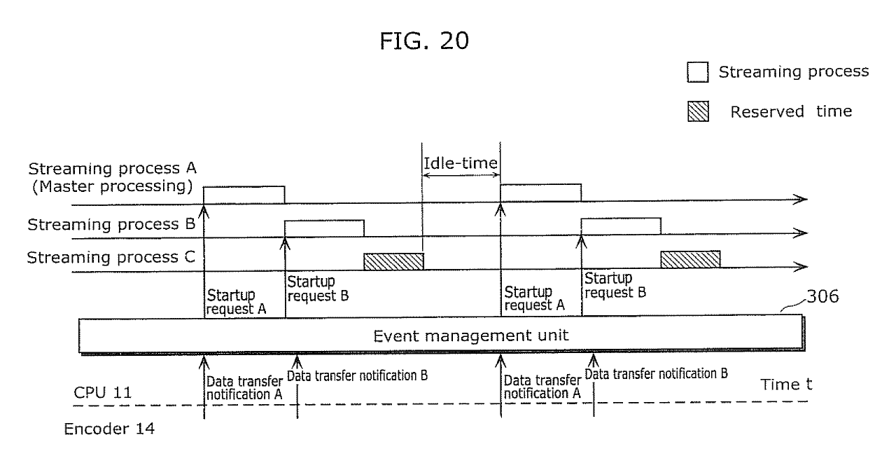

In this manner, according to the stream controller 400 in the present embodiment, by adding the area of reserved process time to the stream management table 480 and including the reserved process time in the streaming process time by the stream management unit 407 so as to perform scheduling, it is possible to guarantee the recording of the stream data in the external storage device as shown in FIG. 20 as well as the cycle process which is a process other than the streaming processes.

### Fifth Embodiment

Next, the fifth embodiment of the present invention is described hereinafter with reference to the diagrams.

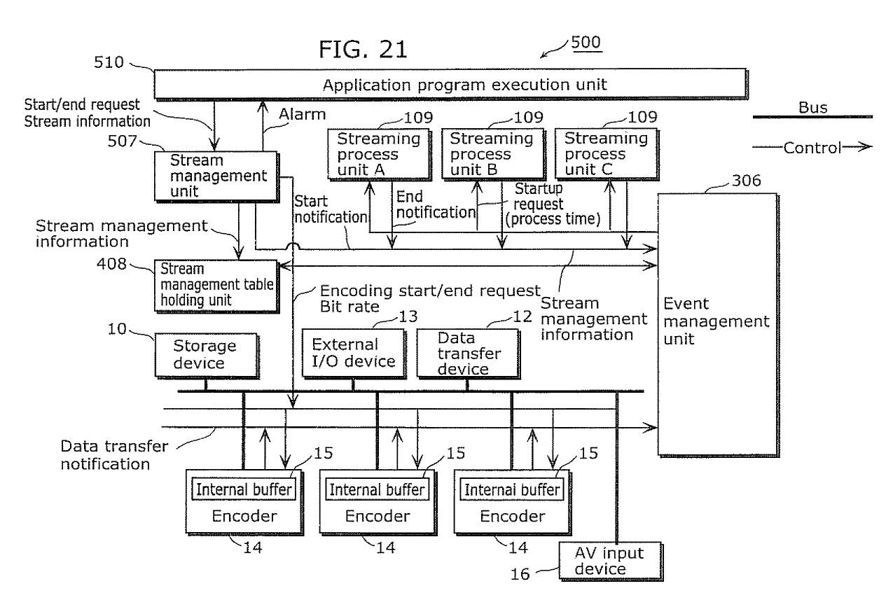

The hardware configuration of the stream controller in the present embodiment is the same as the hardware configuration of the stream controller of the fourth embodiment. However, in the functional configuration, as shown in FIG. 21, instead of the stream management unit 407 and application program execution unit 410, the stream controller of the fifth embodiment differs in having a stream management unit 507 and an application program execution unit 510. In addition, it is also characterized in modifying the processing control flow of the stream management unit 407 by adding an alarm notification process from the stream management unit 407 to the application program execution unit 410.

Moreover, according to the fourth embodiment of the stream controller 400, in the case where the streaming process is not started due to the lack of idle-time in the stream management unit 407, the application program execution unit 410 can not accurately know the running out of the idle-time.

For example, after having failed in a start of a streaming process C, even when the streaming process B ends and the streaming process C starts, it is not possible to guarantee the start of the streaming process C.

However, this point is improved in the stream controller of the present embodiment.

Taking the aforementioned points into consideration, the stream controller in the present embodiment is described. It should be noted that the description is omitted in the case where the components of the stream controller in the fifth embodiment are the same as those of the stream controller 400 in the fourth embodiment, as the same reference numbers are used in the description.

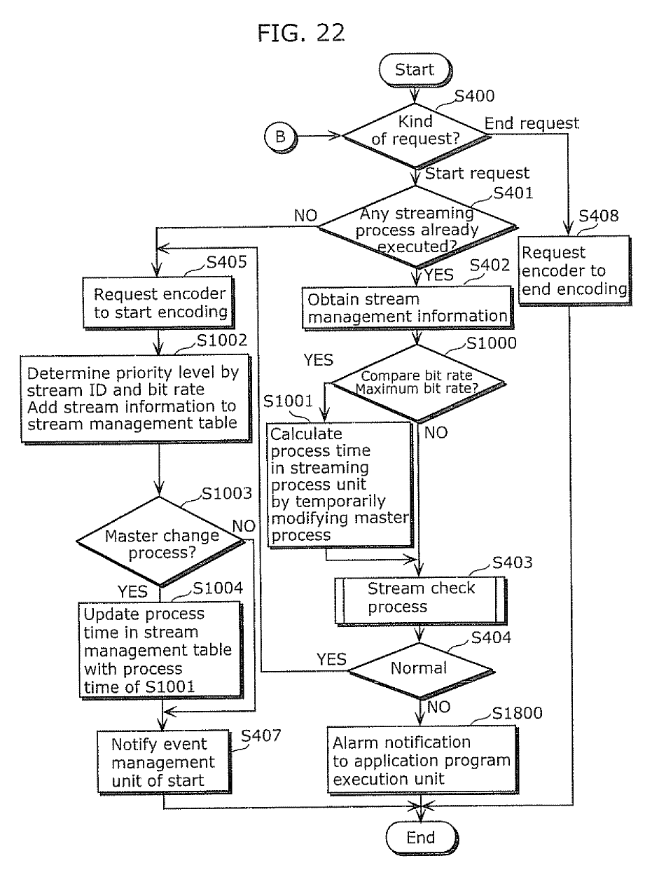

FIG. 22 is a flowchart of the stream management unit 507 in the fifth embodiment.

As shown in FIG. 22, when the stream management unit 507 receives a recording process start request from the application program execution unit 510, in the stream check process (S403), it is judged whether or not the streaming process can be started. In the case where the streaming process can not be started due to the lack of idle-time (S404), as alarm information, the running out of time is notified to the application program execution unit 510 (S1800). With this, the application program execution unit 510 can add and delete the streaming process based on the notified time information.

In this manner, according to the stream controller 500 in the present embodiment, by adding a process in that the stream management unit 507 notifies the application program execution unit 510 of alarm information so that the application program execution unit 510 can accurately know the idle-time for the streaming process and judge whether or not the streaming process can be started before adding a streaming process.

Moreover, instead of notifying the alarm information, the stream management unit 507 may notify the application program execution unit 510 of the idle-time at the time when the stream management table 480 is updated.

### Sixth Embodiment

Next, the sixth embodiment of the present invention is described hereinafter with reference to the diagrams.

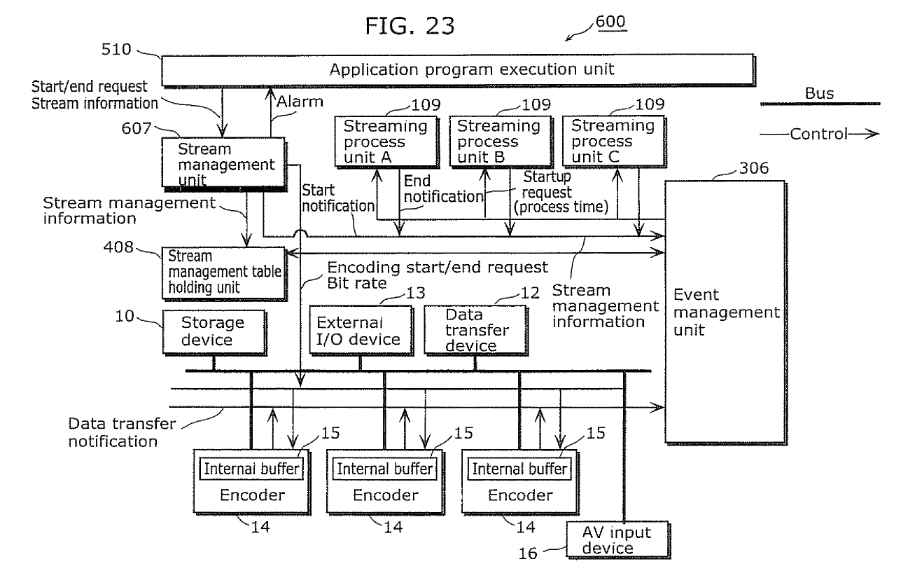

The hardware configuration of the stream controller in the present embodiment is the same as the hardware configuration of the stream controller 500 of the fifth embodiment. However, in the functional configuration, as shown in FIG. 23, instead of the stream management unit 507, it differs in having a stream management unit 607. In addition, it is also characterized in modifying the process control flow of the stream management unit 507 by adding, to the stream management unit 507, a process in which a recording bit rate of a stream is recalculated.

Moreover, according to the stream controller 500 of the fifth embodiment, in the case where a streaming process can not be started due to the lack of idle-time in the stream management unit 507, the streaming process which is to be started can not be started without deleting the stream which is in execution.

However, this point is improved in the stream controller of the present embodiment.

Taking the aforementioned points into consideration, the stream controller in the present embodiment is described. It should be noted that the description is omitted in the case where the components of the stream controller in the sixth embodiment are the same as those of the stream controller 500 in the fifth embodiment, as the same reference numbers are used in the description.

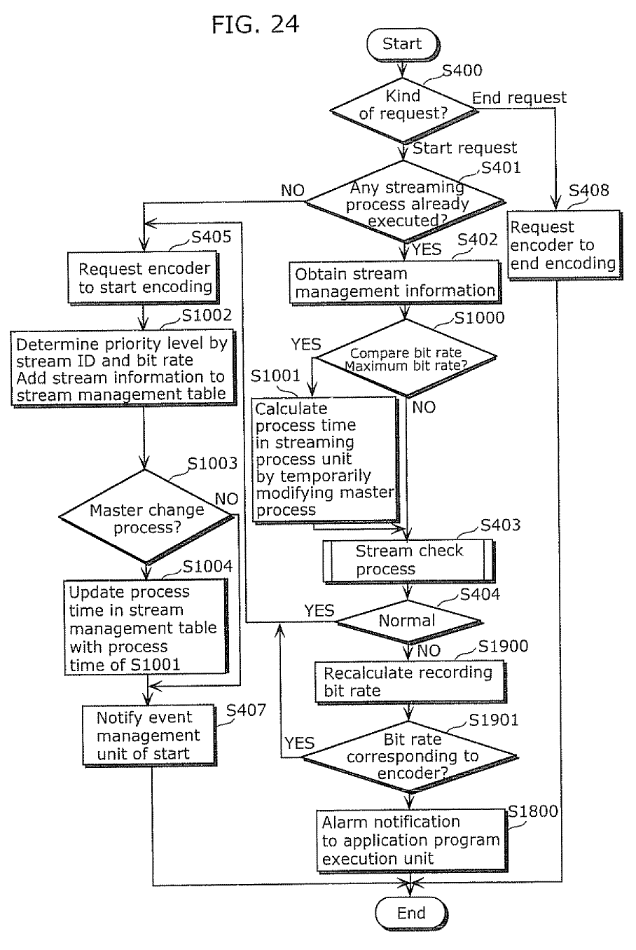

FIG. 24 is a flowchart of the stream management unit 607 in the sixth embodiment.

Moreover, the flowchart is different from the control flow of the stream management unit 507 in the fifth embodiment in the following points (refer to FIG. 22).

As shown in FIG. 24, when the stream management unit 607 receives a recording process start request from the application program execution unit 510, in the stream check process (S403), it is judged whether or not the streaming process can be started. In the case where the streaming process can not be started due to the lack of idle-time (S404), the bit rate of stream is calculated so as to perform, within the idle-time, the streaming process to be started (S1900). Compared to the default bit rate, the bit rate actually designated in the encoder 14 is calculated by the ratio of idle-time and streaming process time as Equation 6.
A bit rate with the priority level N=A default bit rate with the priority level N*(Idle-time/Streaming process time with the priority level N) (Equation 6)

Then, in the case where the encoder 14 supports a set point which is equal to or less than the bit rate after calculation (S1901), the streaming process is started. When it is not supported, the process ends by a notification of the alarm.

In this manner, according to the stream controller 600 in the present embodiment, by adding a process which recalculates a recording bit rate in the stream management unit 607, the streaming process which can not be started due to the lack of idle-time can be guaranteed.

Moreover, the recording bit rate may be recalculated in the application program execution unit 510 by notifying the alarm information as in the fifth embodiment in order to determine the recording bit rate interactively with the user.

### Seventh Embodiment

Next, the seventh embodiment of the present invention is described hereinafter with reference to the diagrams.

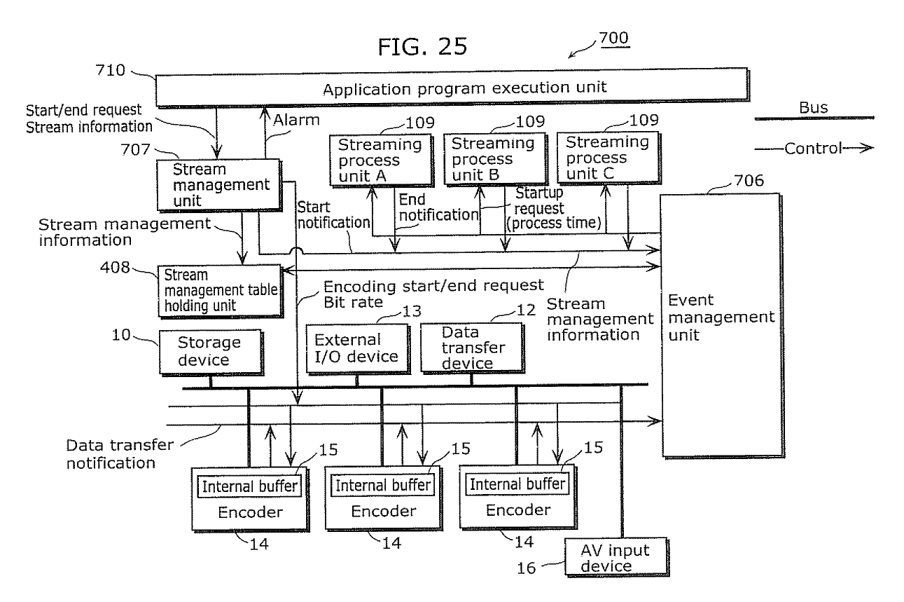

The hardware configuration of the stream controller in the present embodiment is the same as the hardware configuration of the stream controller 600 of the sixth embodiment. However, in the functional configuration, as shown in FIG. 25, instead of the event management unit 306, stream management unit 607 and application program execution unit 510, it differs in having an event management unit 706, a stream management unit 707, and an application program execution unit 710. In addition, it is also characterized in modifying the process control flow of the stream management unit 607 by adding a bit rate change notification for a streaming process from the application program execution unit 510 to the stream management unit 607 and adding a bit rate change process in the stream management unit 607.

Moreover, the stream controller 600 in the sixth embodiment operates so as to guarantee the streaming process which is once started. Therefore, when the streaming process of a certain bit rate is started, it can not be guaranteed that the succeeding streaming process to be started is recorded with a designated bit rate.

For example, in the case where a user desires to record a stream with a high priority level, unless idle-time is present, the recording may not be started without deleting the streaming process during execution or lowering the bit rate.

However, according to the stream controller in the present embodiment, this point is improved.

Taking the aforementioned points into consideration, the stream controller in the present embodiment is described. It should be noted that the description is omitted in the case where the components of the stream controller in the seventh embodiment are the same as those of the stream controller 600 in the sixth embodiment, as the same reference numbers are used in the description.

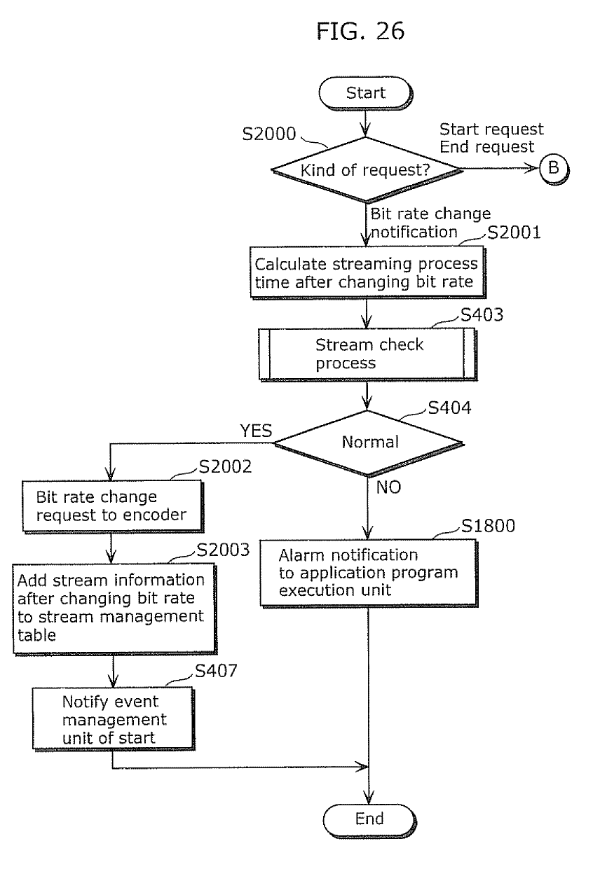

FIG. 26 is a flowchart of the stream management unit 707 in the seventh embodiment.

Compared to the control flow of the stream management unit 607 in the sixth embodiment (refer to FIG. 22), the control flow is the same in the case of receiving start and end requests from the application program execution unit 610.

However, as shown in FIG. 26, when the stream management unit 707 receives a bit rate change notification from the application program execution unit 710 (S2000), the process time of the streaming process in which a bit rate is changed is recalculated (S2001).

Here, the calculation method of process time at the time of the bit rate change is the same as the method in the fifth embodiment (S1900).

Then, after the process time calculation, the stream check process (S403) is performed, and in the case where a bit rate for the master streaming process is changed, the stream check process is performed by assuming that the streaming process in which the second highest bit rate is used as the master process.

In the case where it is judged that changing the bit rate of the streaming process does not affect other streaming processes (S404), the bit rate setting for the encoder 14 is changed (S2002).

Furthermore, the streaming process time after the bit rate change and the priority level are registered in the stream management table 480 (S2003). Finally, the process ends by notifying the event management unit 706 of a start of the streaming process (S407) in order to reflect information of the stream management table 480 to the scheduling executed in the event management unit 706.

In this manner, according to the stream controller 700 in the present embodiment, by adding a process for changing the bit rate of a recording stream in the stream management unit 707, it is possible for the user to provide an instruction for changing the priority level of the streaming process. Therefore, in the case where idle-time is running out, the idle-time is created by not only deleting the streaming process but also changing the bit rate of stream so that the user can have an option of newly adding a streaming process

### Eighth Embodiment

Next, the eighth embodiment of the present invention is described hereinafter with reference to the diagrams.

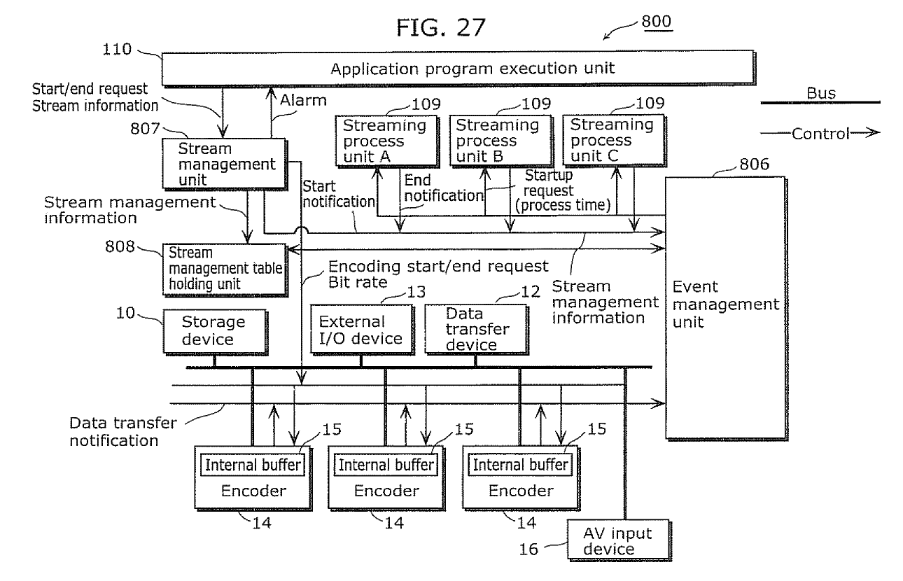

The hardware configuration of the stream controller in the present embodiment is the same as the hardware configuration of the stream controller of the first embodiment. However, in the functional configuration, as shown in FIG. 27, instead of the event management unit 106, stream management unit 107, and stream management table holding unit 108, it differs in having an event management unit 806, a stream management unit 807, and a stream management table holding unit 808. In addition, it is characterized in modifying process control flow of the event management unit 106 and stream management unit 107 by adding Information of an attribute flag and the corresponding ID to the components of the stream management table 180 and adding a variable bit rate stream (VBR) control process to the event management unit 106 and stream management unit 107.

Moreover, according to the stream controller 100 in the first embodiment, the stream information registered in the stream management table 180 is all registered as a constant bit rate (CBR) stream. In this case, it is not possible to handle a variable bit rate (VBR) stream in which the bit rate of the stream is changed depending on an image inputted from the AV input device 16. As a result, the varied data is accumulated and an overflow of the buffer occurs.

However, this point is improved in the stream controller of the present embodiment.

Taking the aforementioned points into consideration, the stream controller in the present embodiment is described. It should be noted that the description is omitted in the case where the components of the stream controller in the eighth embodiment are the same as those of the stream controller 100 in the first embodiment, as the same reference numbers are used in the description.

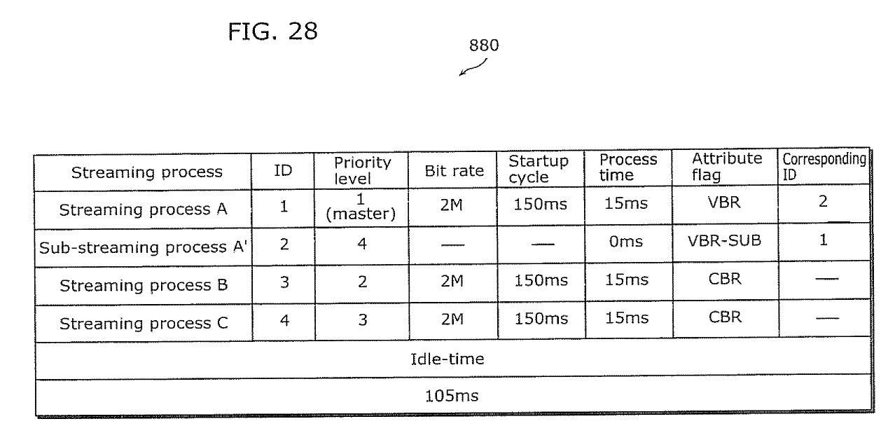

FIG. 28 is a diagram of configuration of the stream management table 880 held in the stream management table holding unit 808 in the eighth embodiment.

As shown in FIG. 28, the stream management table 880 manages an attribute flag and the corresponding ID, aside from the information of the stream management table 180 of the first embodiment (refer to FIG. 4).

In the table section of the attribute flag, information indicating either a variable bit rate (VBR) stream, a constant bit rate (CBR) stream, or a VBR sub-stream (VBR-SUB) is registered In addition, the corresponding ID is used for indicating a relationship between stream information and sub-stream information.

In FIG. 28, in order to show a correspondence between a stream with a stream ID 1 and a stream with a stream ID 2, 2 is registered as a corresponding ID for a VBR stream with the stream ID 1, and 1 is registered as a corresponding ID for VBR sub-stream information with the stream ID 2. In addition, when the sub-stream information is registered, the bit rate of stream, startup cycle, and process time are not registered as unnecessary information, and the process time is registered as 0.

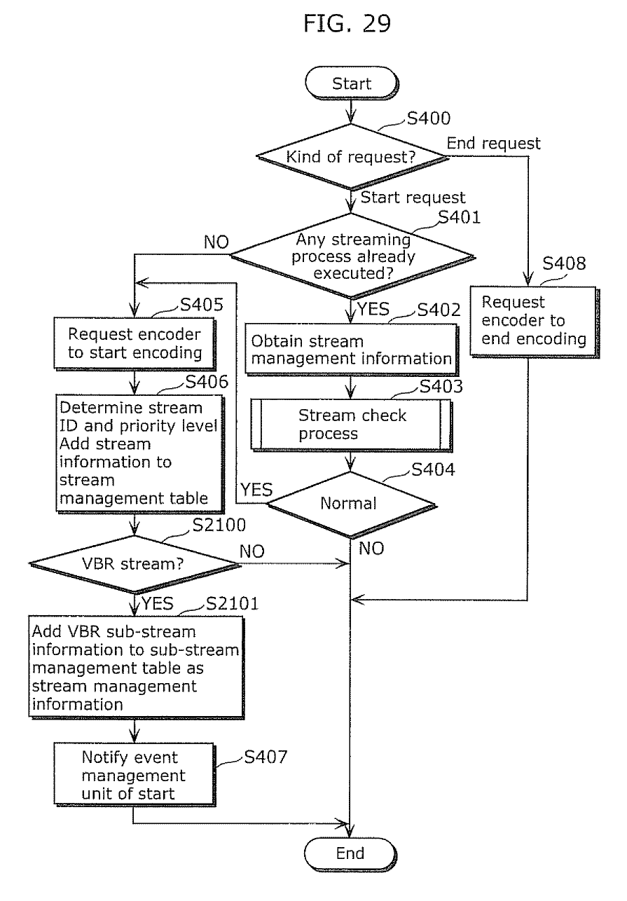

FIG. 29 is a flowchart of the stream management unit 807 in the eighth embodiment.

Moreover, compared to the control flow of the stream management unit 107 of the first embodiment (refer to FIG. 5), processes of S2100 and S2101 are added, and by including a step of judging an constant bit rate or a variable bit rate, the process of a variable bit rate stream is enabled.

Moreover, an attribute flag is registered as stream information in the process of Step S406. In addition, the corresponding ID is registered as sub-stream information in the process of Step S2101.

Moreover, when the sub-stream information is registered in the process of Step S2101, the bit rate of stream, startup cycle, and process time are not registered as unnecessary information, and the process time is registered as 0.

As shown in FIG. 29, the stream management unit 807 detects a recording start request from the application program execution unit 110, and after registering the stream information to the stream management table 880 (S406), it is judged whether it is a VBR stream (S2100). When it is not, the end process is performed. When it is a VBR stream, the VBR sub-stream information corresponding to the stream information is added to the stream management table (S2101).

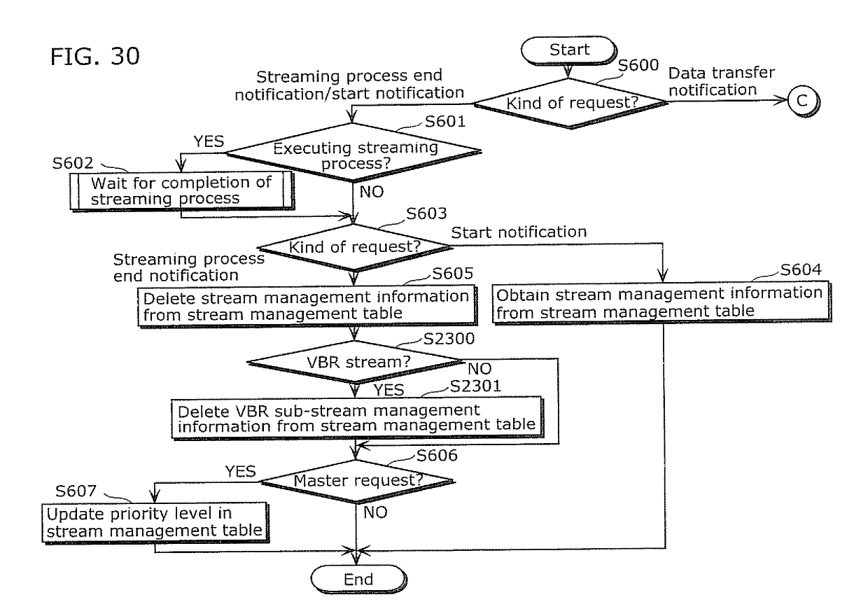

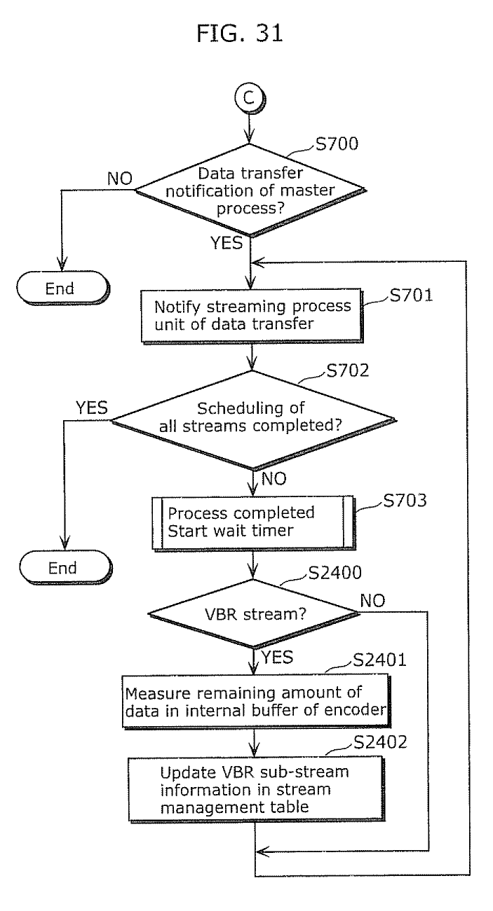

FIG. 30 and FIG. 31 are diagrams showing flowcharts of the event management unit 806 in the eighth embodiment.

Moreover, compared to the control flow of the event management unit 106 in the first embodiment (refer to FIGS. 6 and 7), processes of Steps S2300, S2301, and S2400 to S2402 are added.

As shown in FIG. 30, the event management unit 806 receives an end notification from the streaming process unit 109, and after deleting the stream management information from the stream management table 880 (S605), it is judged whether the stream is a VBR stream (S2300). When it is a VBR stream, the corresponding ID is referred to, and the sub-stream information corresponding to the stream deleted in the process of Step S605 is deleted from the stream management table (S2301).

Furthermore, as shown in FIG. 31, the event management unit 806 performs a process in the case of receiving data transfer notification from the encoder 14, in other words, a process that waits until the process of the streaming process unit 109 already started ends (S703). After the timer notifies that the time is up, it is judged whether or not it is the VBR stream (S2400). In the case of the VBR stream, the remaining amount of data in the internal buffer 15 of the encoder 14 is measured (S2401). After calculating the process time from the remaining amount of data using the following Equation 7, a sub-streaming process corresponding to the VBR stream is searched by referring to the corresponding ID in the stream management table, and the process time is updated. In addition, in order to allocate idle-time for the sub-streaming process, the process time of the sub-streaming process is subtracted from the idle-time so as to update the idle-time (S2402).
Process time=Max (Remaining amount of data/Data processing speed in the streaming process unit) (Equation 7)

Moreover, in Step S2402, in the case where the idle-time is less than the process time of the sub-streaming process, maximum value of the idle-time is allocated, and the update process for idle-time and process time is performed. In addition, in the case where no data remains, the process time is registered as 0, and the registered stream is started without starting the timer in Step S703.

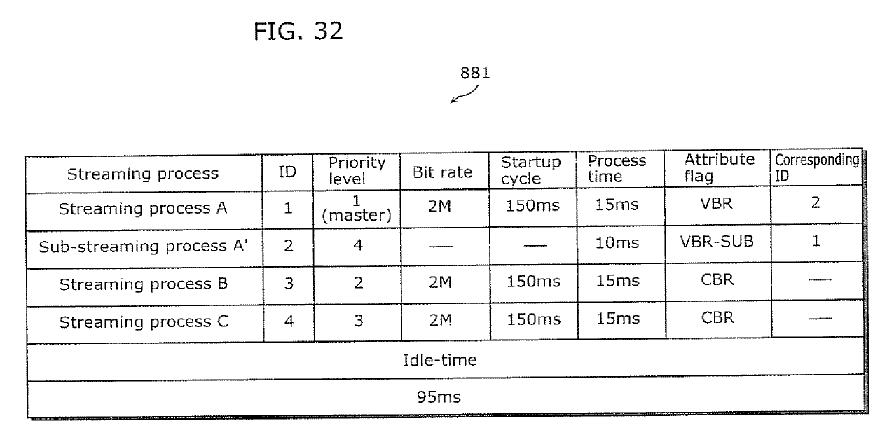

FIG. 32 is a diagram showing that the process time and idle-time of the sub-stream with the ID 2 are updated in the stream management table 880 (refer to FIG. 28) by the process of Step S2402 (refer to FIG. 31). Moreover, 10 ms is registered as the process time of a sub-streaming process A′ in the stream management table 881 (refer to FIG. 32), and the process time is subtracted from the idle-time. As a result, 105 ms-10 ms=95 ms is registered as new idle-time.

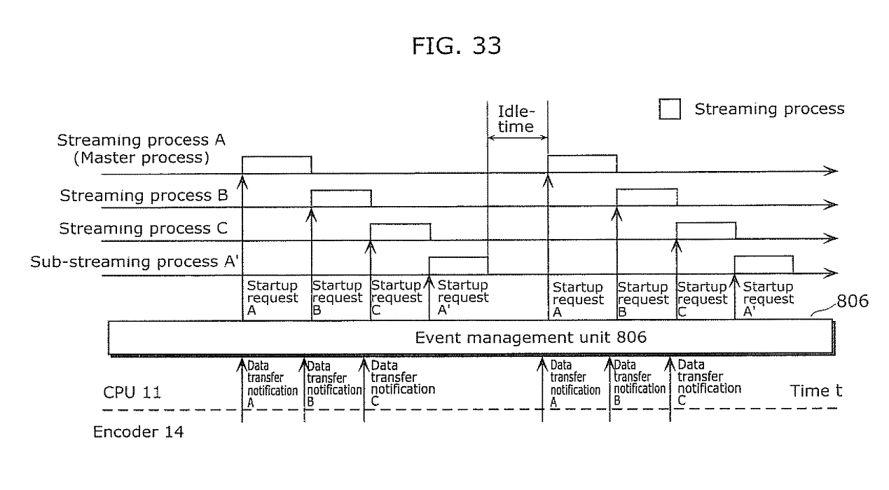

In this manner, according to the stream controller 800 in the present embodiment, each time the event management unit 806 notifies the streaming process unit 109 of a start request, the internal buffer 15 of the encoding 14 is measured. As the process in which stream information of the stream management table 880 is updated is added so as to process, by the next start request, the remaining amount of data which can not be processed, as shown in FIG. 33, the process can be performed by allocating the time used as idle-time to the sub-streaming process. This can be applied to a streaming process with a variable bit rate. In addition, only when the bit rate becomes equal to or larger than the bit rate with which the stream is registered, the streaming process unit 109 performs a transfer process of data remained in the internal buffer 15. As the idle-time is used only when necessary, the idle-time can be used for other processes.

### Ninth Embodiment

Next, the ninth embodiment of the present invention is described hereinafter with reference to the diagrams.

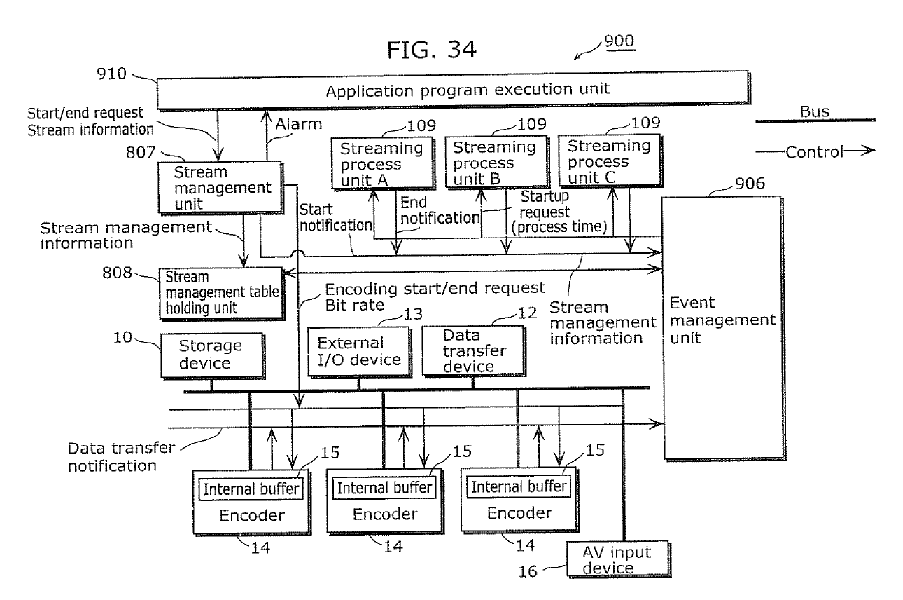

The hardware configuration of the stream controller in the present embodiment is the same as the hardware configuration of the stream controller of the eighth embodiment. However, in the functional configuration, as shown in FIG. 34, instead of the event management unit 806 and application program execution unit 110, it differs in having an event management unit 906 and an application program execution unit 910. In addition, it is characterized in modifying the processes control flow of the event management unit 806 by adding an alarm notification process from the event management unit 806 to the application program execution unit 110.

Moreover, according to the stream controller 800 in the eighth embodiment, as idle-time is allocated to a sub-streaming process by the process of a variable bit rate (VBR) stream, in the case where process time of the sub-stream in the stream management table 880 increases, there is a possibility that the idle-time may be running out. However, the application program execution unit 110 can not know a state that the idle-time is running out.

For example, in the case where the application program execution unit 110 does not perform a stop process of the stream and a state where the idle-time is running out continues, there is a danger that the internal buffer 15 of the encoder 14 may overflow, and the operation of the system cannot be guaranteed.

However, this point is improved in the stream controller of the present embodiment.

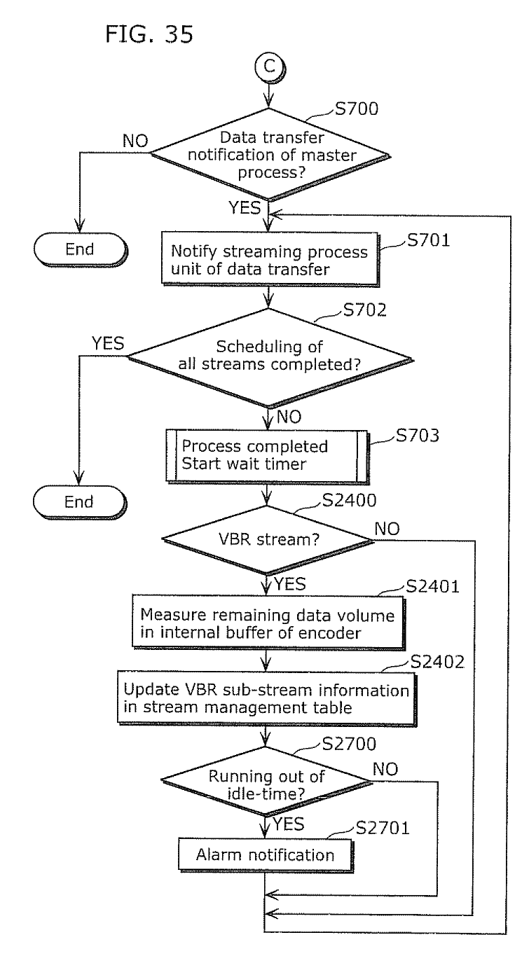

FIG. 35 is a diagram of a flowchart of the event management unit 906 in the ninth embodiment.

Moreover, the following points are different compared to the control flow of the event management unit 806 in the eighth embodiment (refer to FIG. 31).

As shown in FIG. 35, the event management unit 906 receives a data transfer notification from the encoder 14, and performs an update process in the stream management table 880 (S2402). It also performs a judgment process in which whether or not the idle-time is running out by comparing the process time calculated from the remaining amount of data to the idle-time (S2700), and in the case where the idle-time is running out, the state is notified to the application program execution unit 910 (S2701).

In this manner, according to the stream controller 900 in the present embodiment, the application program execution unit 910 can accurately know the idle-time for a streaming process by adding the process that the event management unit 906 notifies the application program execution unit 910 of alarm information, and it is possible to prevent the internal buffer 15 from overflowing by performing, with the application program execution unit 910, processes such as a stop of a streaming process and change of a bit rate.

### Tenth Embodiment

Next, the tenth embodiment of the present invention is described hereinafter with reference to the diagrams.

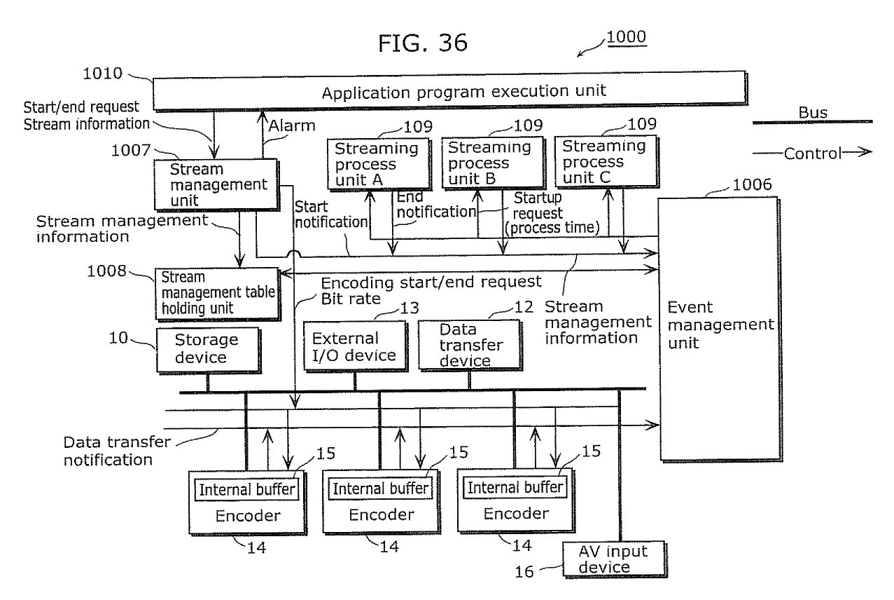

The hardware configuration of the stream controller in the present embodiment is the same as the hardware configuration of the stream controller of the first embodiment. However, in the functional configuration, as shown in FIG. 36, instead of the event management unit 106, stream management unit 107, stream management table holding unit 108 and application program execution unit 110, it differs in having an event management unit 1006, a stream management unit 1007, a stream management table holding unit 1008 and an application program execution unit 1010. In addition, it is also characterized in modifying the process control flows of the event management unit 106 and stream management unit 107 by adding a cycle flag as components of the stream management table 180 and adding, to the event management unit 106 and stream management unit 107, a control process which is operated non-cyclically.

Moreover, according to the stream controller 100 of the first embodiment, stream information registered in the stream management table 180 is encoded in the encoder 14 with a predetermined bit rate, and a stream in which a streaming process is cyclically performed in the streaming process unit 109 is used as an object for registration. In this case, a stream in which a start request non-cyclically occurs, such as a static image recording process, is not supported. As the process is performed during the idle-time of the streaming process which is cyclically started, the application program execution unit 110 does not know an end time of the non-cyclical streaming process.

However, this point is improved in the stream controller of the present embodiment.

Taking the aforementioned points into consideration, the stream controller in the present embodiment is described. It should be noted that the description is omitted in the case where the components of the stream controller in the tenth embodiment are the same as those of the stream controller 100 in the first embodiment, as the same reference numbers are used in the description.

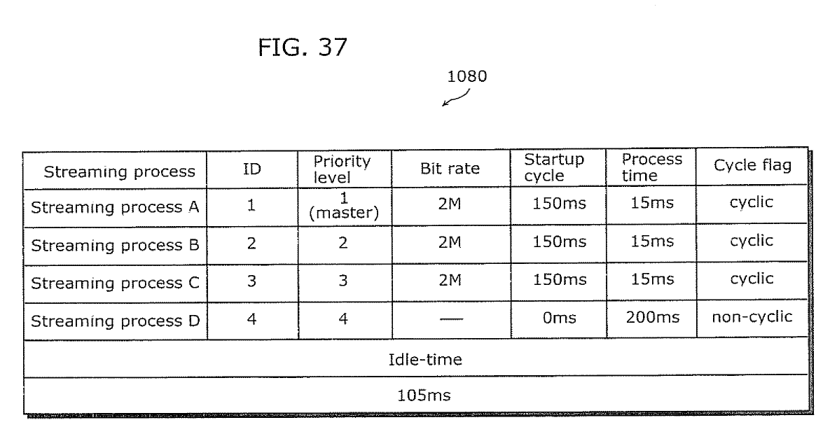

FIG. 37 is a diagram showing the configuration of the stream management table 1080 held in the stream management table holding unit 1008 in the tenth embodiment.

As shown in FIG. 37, the stream management table 1080 manages a cycle flag aside from information of the stream management table 180 in the first embodiment (refer to FIG. 4).

In the table section of the cycle flag, information for judging a cyclic stream (cyclic) or a non-cyclic stream (non-cyclic) is registered. In addition, the stream management table 1080 shows that streams with the stream ID 1 to 3 are registered as cyclic streams and a stream with a stream ID 4 is registered as a non-cyclic stream.

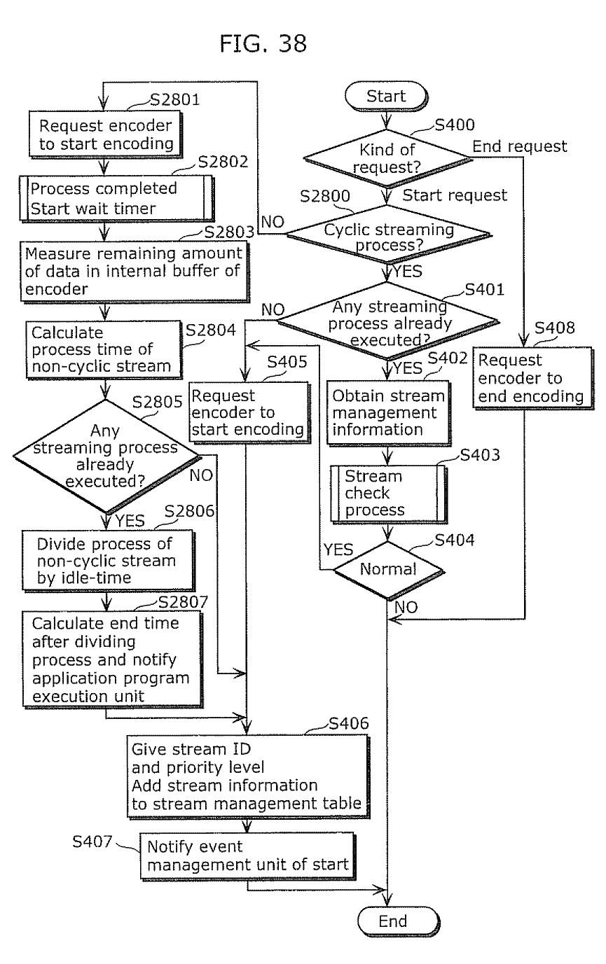

FIG. 38 is a diagram showing a flowchart of the stream management unit 1007 in the tenth embodiment.

Moreover, compared to the control flow of the stream management unit 107 in the first embodiment (refer to FIG. 5), processes of Steps S2800 to S2807 are added, and it is possible to process non-cyclic streams by having a step of judging a cyclic streaming process or a non-cyclic streaming process. Moreover, the cycle flag is information registered as stream information in the process of Step S406.

As shown in FIG. 38, the stream management unit 1007 detects a recording start request from the application program execution unit 1010, and judges whether or not the stream is a cyclic stream (S2800). In the case where it is not a cyclic stream, the stream management unit 1007 judges it as a non-cyclic stream. Then, it requests a start of encoding to the encoder 14 (S2801), performs a process that waits for completion of the encoding (S2802), measures the amount of data accumulated in the internal buffer 15 after the completion of the encoding (S2803), and calculates time required for the non-cyclic streaming process from the amount of data and the streaming process time in the streaming process unit 109 (S2804). In order to confirm the time for which a non-cyclic streaming process can be executed, it is judged whether or not the streaming processes which is already in execution is present (S2805). In the case where such stream is not present, it is judged that there is no constraint on streaming process time of the non-cyclic stream, and the stream information is registered in the stream management table 1080 (S406). In the case where the stream which is already in execution is present, the idle-time is obtained from the stream management information in the stream management table 1080, and the streaming process is divided by the number of stream process division calculated in Equation 8 (S2806).
The number of stream process division=(Process time/Idle-time)+1 (Equation 8)

Next, for calculating an end time of the streaming process, a startup cycle of a process with the priority level 1 is obtained from the stream management table 1080, calculation is performed by Equation 9, and the calculation result is notified to the application program execution unit 1010 (S2807).
Streaming process end time=A startup cycle of the process with the priority level 1*The number of stream process division (Equation 9)

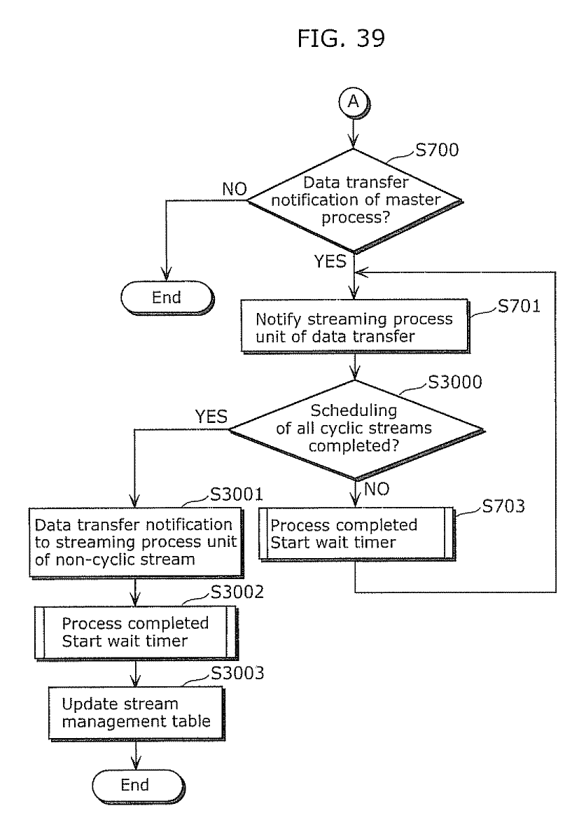

FIG. 39 is a diagram showing a flowchart of the event management unit 1006 in the tenth embodiment.

Moreover, compared to the control flow of the event management unit 106 in the first embodiment (refer to FIG. 7), processes of Steps S3000 to S3003 are added.

As shown in FIG. 39, after the event management unit 1006 notifies the streaming process unit 109 of data transfer (S701), it refers to the cycle flag of the stream management information in the stream management table 1080 and judges completion of scheduling of all cyclic streaming processes (S3000). After completion of scheduling of all cyclic streaming processes, the event management unit 1006 starts a non-cyclic stream process (S3001-S3003). First, the event management unit 1006 notifies data transfer to the streaming process unit 109 of a non-cyclic stream registered in the stream management table 1080 (S3001) and refers to the idle-time of the non-cyclic stream in the stream management table 1080. In the case where the process time of the non-cyclic stream is longer than the idle-time, a timer is started during the idle-time. In the case where the process time of the non-cyclic stream is equal to or less than the idle-time, by starting the timer during the process time of the non-cyclic stream, the event management unit 1006 waits the time when the operating streaming process unit 109 ends (S3002). Regarding the process time of the non-cyclic stream in the stream management table 1080, in the case where the process time of the non-cyclic stream is longer than the idle-time, the process time in the stream management table 1080 is updated by the value obtained by subtracting the idle-time from the process time. In the case where the process time of the non-cyclic stream is equal to or less than the idle-time, 0 is inputted as the process time (S3003).

In this manner, according to the stream controller 1000 in the present embodiment, the stream management unit 1007 can judge whether a stream is a cyclic stream or a non-cyclic stream, and predict an end time of the non-cyclic stream at the timing of registering the stream's process time and the like in the stream management table 1080.

Moreover, although FIG. 2 and FIG. 3 show examples of the configuration made up of a plurality of the encoders 14, it is not necessary to be limited to these examples, and plural units of encoding may be executed in parallel using a DSP. In addition, instead of the data transfer device 12, common memory may be used.

Moreover, a program executed in the present stream controller and in which one or more functions in the present invention are realized (hereinafter referred to as a “stream control program”) may be recorded in computer-readable recording media, such as an optics recording medium (for example, CD-ROM), a magnetic recording medium (for example, a hard disk), a magneto-optical recording medium (for example, MO), and semiconductor memory (for example, a memory card), so as to be read in hardware systems, such as a computer system and an installation system. In addition, the program may be executed in other hardware systems via such recording media.

Furthermore, the program may also be executed in other hardware systems in which a stream control program is downloaded via a network, by holding a stream control program in a hardware system on the network.

Although the present invention is described based on the embodiments as described above, the present invention is not limited to these embodiments and can be modified without departing from the scope of the main points of the description.

### INDUSTRIAL APPLICABILITY

The stream controller and the stream control method in the present invention are for recording a plurality of audio and video streams with high efficiency and accuracy without reducing efficiency of process time for a plurality of streams, and can also be applied to: portable terminal devices which simultaneously record the audio and video streams inputted from a camera or a tuner; and use for recording audio and video with an application on a Personal Computer (PC) in real time.

What is claimed is:

1. A stream controller which has a plurality of encoders that respectively encode a stream and which starts, for every encoder, a streaming process for transferring encoded stream data to an external storage device, said stream controller comprising:
a stream management table holding unit which holds a stream management table in which a priority level given to a streaming process, process time allocated to the streaming process, and a startup cycle designated for the streaming process are registered for every streaming process;
a stream management unit operable to designate, as a standard process, a streaming process with a highest priority level among the streaming processes registered in the stream management table, and to allocate process time to a streaming process to be registered in the stream management table under a condition that all of the streaming processes registered in the stream management table are sequentially performed within a startup cycle of the standard streaming process; and
an event management unit operable to reallocate process time to each streaming process under a condition that the streaming processes are performed in accordance with the priority levels given to each streaming process and within the startup cycle of the standard streaming process.

2. The stream controller according to claim 1,
wherein said event management unit is operable to synchronize a start time of a second streaming process with an end time of a first streaming process in the case where a process with a higher priority level is the first streaming process and a process with a lower priority level is the second streaming process among the streaming processes registered in the stream management table.

3. The stream controller according to claim 1,
wherein said stream management unit is operable to designate, as the standard streaming process, a streaming process in which a maximum bit rate for encoding is allocated, and to reallocate, within the startup cycle of the standard streaming process, process time for other streaming processes registered in the stream management table.

4. The stream controller according to claim 1,
wherein preprocess time and post-process time are registered for every streaming process in the stream management table, and
said stream management unit is operable to allocate, based on time in which the preprocess time, the post-process time and the process time of the streaming process are added, process time to the streaming process to be registered under a condition that all of the streaming processes registered in the stream management table are performed within the startup cycle designated by the standard streaming process.

5. The stream controller according to claim 1,
wherein reserved process time is registered for every streaming process in the stream management table, and
said stream management unit is operable to allocate process time to the streaming process to be registered under a condition that all of the streaming processes registered in the stream management table are performed within the startup cycle of the standard streaming process in consideration of the reserved process time.

6. The stream controller according to claim 4,
wherein said event management unit is operable to synchronize a start time of a second streaming process with an end time of a first streaming process based on the streaming process time in the case where a process with a higher priority level is the first streaming process and a process with a lower priority level is the second streaming process among the streaming processes registered in the stream management table.

7. The stream controller according to claim 5,
wherein said event management unit is operable to synchronize a start time of a second streaming process with an end time of a first streaming process based on the streaming process time in the case where a process with a higher priority level is the first streaming process and a process with a lower priority level is the second streaming process among the streaming processes registered in the stream management table.

8. The stream controller according to claim 1, further comprising
an application program execution unit operable to execute an application program,
wherein said stream management unit is operable to output an alarm signal to said application program execution unit in the case where all of the streaming processes can not be performed within the startup cycle of the standard streaming process.

9. The stream controller according to claim 1,
wherein said stream management unit is operable to change a bit rate for encoding of each streaming process in the case where all of the streaming processes can not be sequentially performed within the startup cycle of the standard streaming process.

10. The stream controller according to claim 1,
wherein said stream management unit is operable to change a bit rate for encoding of a streaming process in which stream data is being transferred to the external storage device, and
said event management unit is operable to redesignate, after changing the bit rate for encoding, a start time of the streaming process in which the stream data is being transferred.

11. The stream controller according to claim 1,
wherein in the stream management table, the following are registered for every streaming process:
an attribute flag which identifies one of a constant bit rate stream and a variable bit rate stream; and
a corresponding ID which identifies a corresponding streaming process, and
wherein said event management unit is operable to judge that a streaming process is one of the constant bit rate stream and the variable bit rate stream based on the attribute flag, and to reallocate, in the case of the variable bit rate stream, process time of the variable bit rate stream based on remaining amount of data in an internal buffer of said encoder and data processing speed in the streaming process, and for every startup cycle of the streaming process.

12. The stream controller according to claim 1,
an application program execution unit operable to execute an application program,
wherein in the stream management table, the following are registered for every streaming process:
an attribute flag which identifies one of a constant bit rate stream and a variable bit rate stream; and
a corresponding ID which identifies a corresponding streaming process, and
wherein said event management unit is operable to:
judge that a streaming process is one of the constant bit rate stream and the variable bit rate stream based on the attribute flag;
reallocate, in the case of the variable bit rate stream, process time of the variable bit rate stream, based on remaining amount of data in an internal buffer of said encoder and process time specified by data processing speed of the streaming process for every startup cycle of the streaming process; and
output an alarm signal to said application program execution unit in the case where the streaming process time reallocated during the process is longer than idle-time up to a start of a streaming process.

13. The stream controller according to claim 1, further comprising
an application program execution unit operable to execute an application program,
wherein a cycle flag which identifies one of a cyclic stream and a non-cyclic stream is registered for every streaming process in the stream management table, and
said stream management unit is operable to:
judge that a stream is one of the cyclic stream and the non-cyclic stream based on the cycle flag;
divide, in the case of the non-cyclic stream, the streaming process of the non-cyclic stream, based on idle-time up to a start of a streaming process and process time of the non-cyclic stream; and
notify said application program execution unit of an end time specified by the divided streaming process.

14. A stream control method for controlling a stream controller which has a plurality of encoders that respectively encode a stream and which starts, for every encoder, a streaming process for transferring encoded stream data to an external storage device, said stream control method comprising:
generating a stream management table in which a priority level given to a streaming process, process time allocated to the streaming process, and a startup cycle designated for the streaming process are registered for every streaming process;
managing a stream by designating, as a standard process, a streaming process with a highest priority level among the streaming processes registered in the stream management table and allocating process time to a streaming process to be registered in the stream management table under a condition that all of the streaming processes registered in the stream management table are sequentially performed within the startup cycle of the standard streaming process; and
managing an event by reallocating process time to each streaming process under a condition that the streaming processes are performed in accordance with the priority levels given to each streaming process and within the startup cycle of the standard streaming process.

15. A stream control program for controlling a stream controller which has a plurality of encoders that respectively encode a stream and which starts, for every encoder, a streaming process for transferring encoded stream data to an external storage device, said program causing a computer system to execute:
generating a stream management table in which a priority level given to a streaming process, process time allocated to the streaming process, and a startup cycle designated for the streaming process are registered for every streaming process;
managing a stream by designating, as a standard process, a streaming process with a highest priority level among the streaming processes registered in the stream management table and allocating process time to a streaming process to be registered in the stream management table under a condition that all of the streaming processes registered in the stream management table are sequentially performed within the startup cycle of the standard streaming process; and
managing an event by reallocating process time to each streaming process under a condition that the streaming processes are performed in accordance with the priority levels given to each streaming process and within the startup cycle of the standard streaming process.
